(19) United States
(12) Patent Application Publication
(10) Pub. No.: US 2022/0268064 A1
(43) Pub. Date: Aug. 25, 2022

(54) CLOSURE LATCH ASSEMBLY WITH CRASH UNLOCK MECHANISM

(71) Applicant: MAGNA CLOSURES INC., Newmarket (CA)

(72) Inventor: Marco TAURASI, Livorno (IT)

(21) Appl. No.: 17/673,710

(22) Filed: Feb. 16, 2022

Related U.S. Application Data
(60) Provisional application No. 63/272,123, filed on Oct. 26, 2021.
(60) Provisional application No. 63/152,232, filed on Feb. 22, 2021.

(51) Int. Cl. E05B 81/06; E05B 77/02; E05B 77/26

(52) U.S. Cl. CPC E05B 81/06; E05B 77/02; E05B 77/26

(57) ABSTRACT

A power latch assembly for motor vehicle closure applications is provided that is normally actuated via electrical signals whereat inside and outside door handles are mechanically disengaged and wherein the inside and outside door handles can be selectively and/or automatically changed for mechanically engaged actuation. The inside door handles can be provided to be mechanically actuatable in direct response to selective disengagement of a child lock and/or a crash condition. The outside door handles can be provided to be mechanically actuatable in direct response to a crash condition.

### CROSS-REFERENCE TO RELATED APPLICATION

This application claims the benefit of U.S. Provisional Application Ser. No. 63/272,123, filed Oct. 26, 2021, and U.S. Provisional Application Ser. No. 63/152,232, filed Feb. 22, 2021, which are both incorporated herein by way of reference in their entirety.

### FIELD

The present disclosure relates generally to automotive door latches, and more particularly, to a power side door latch assembly equipped with a door handle mechanical release mechanism.

### BACKGROUND

This section provides background information related to automotive door latches and is not necessarily prior art to the concepts associated with the present disclosure.

A vehicle closure panel, such as a side door for a vehicle passenger compartment, is hinged to swing between open and closed positions and includes a latch assembly mounted to the door. The latch assembly functions in a well-known manner to latch the door when it is closed, lock the door in its closed position, and unlatch and release the door to permit subsequent movement of the door to its open position. As is also well known, the latch assembly is configured to include a latch mechanism for latching the door, a lock mechanism interacting with the latch mechanism for locking the door, and a release mechanism interacting with the lock mechanism for unlocking and unlatching the door. These mechanisms can be manually-operated via an inside and outside door handle and/or power-operated to provide the desired level of standard features. In known latch assemblies, if the latch mechanism is both power and mechanically actuatable, the ability to utilize power and mechanical release mechanisms continuously coexist, such that the user can use either the power or mechanical mechanism at any time to actuate the latch mechanism. Accordingly, the latch mechanism can be unlatched via power or mechanical actuation of the inside and outside doors handle at any time.

It is desired to have a latch mechanism that is actuatable in normal operating conditions via powered actuation, while simultaneously remaining unactuatable via mechanical actuation of the inside and outside door handles. However, it is also desired to be able to selectively or automatically alter the latch mechanism so that it can be manually actuated via the inside and outside door handles, such as when a child lock is disengaged or in a crash condition, or at some other desired time to allow the door to be manually opened.

Thus, there remains a need to develop alternative arrangements for latch mechanisms for use in vehicular side door latches which selectively alter the latch mechanism so that it remains solely actuatable via power actuation in normal operating conditions and selectively or automatically transitioned for mechanical actuation when desired.

### SUMMARY

This section provides a general summary of the disclosure, and is not intended to be a comprehensive and exhaustive listing of all of its features or its full scope.

It is an object of the present disclosure to provide a power latch assembly for motor vehicle closure applications that is normally actuated via electrical signals whereat inside and outside door handles are mechanically disengaged and wherein the inside and outside door handles can be selectively and/or automatically changed for mechanically engaged actuation.

In accordance with another object of the disclosure, the inside door handles can be provided to be mechanically actuatable in direct response to selective disengagement of a child lock.

In accordance with another object of the disclosure, the inside and outside door handles can be provided for automated mechanical actuation in direct response to a crash condition.

In accordance with the above objects, one aspect of the disclosure provides a power latch assembly for a vehicle door including a ratchet configured for movement between striker capture and striker release positions and being biased toward the striker release position. The power latch assembly includes a pawl configured for movement between a ratchet holding position whereat the pawl maintains the ratchet in the striker capture position and a ratchet releasing position whereat the pawl releases the ratchet to the striker release position. A pawl release lever is configured to selectively move the pawl between the ratchet holding position and the ratchet releasing position. An override release mechanism is configured for mechanical actuation by at least one of an inside door handle and an outside door handle, wherein the override release mechanism is moveable between a disengaged position, whereat the override release mechanism is disengaged from operable communication with the pawl release lever, and an engaged position, whereat the override release mechanism is engaged in operable communication with the pawl release lever. The power latch assembly further includes a power release actuator system configured to control powered actuation of the pawl release lever to move the pawl between the ratchet holding position and the ratchet releasing position and to maintain the override release mechanism in the disengaged position during normal operation of the latch assembly and to selectively move the override release mechanism to the engaged position.

According to another aspect of the present disclosure, the power latch assembly can be provided including a motor and a drive gear driven by the motor, with the drive gear being in meshed engagement with a power release gear having a release cam fixed thereto. Further, an actuator output lever can be configured for movement in response to movement of the release cam, wherein the actuator output lever is configured to move the pawl release lever to move the pawl between the ratchet holding and releasing positions.

According to another aspect of the present disclosure, the override release mechanism of the power latch assembly can be provided including a release lever operably connected with at least one of the inside and outside door handle and a link member configured for movement in response to movement of the release lever. The link member being moveable to a decoupled position with the actuator output lever to maintain the override release mechanism in the disengaged position during normal operation of the latch assembly and to a coupled position with the actuator output lever to move the override release mechanism to the engaged position.

According to another aspect of the present disclosure, the latch assembly can be provided including a lug operably fixed to the power release gear for conjoint rotation therewith, with the lug operably moving the link member to the coupled position with the actuator output lever to move the override release mechanism to the engaged position either selectively or in automated response to a crash condition.

According to another aspect of the present disclosure, the power release gear can be provided to rotate in a first direction from a neutral position to an unlatched position to cause the actuator output lever to move the pawl release lever into engagement with the pawl to move the pawl to the ratchet releasing position and the power release gear can be provided to rotate in a second direction opposite the first direction from the unlatched position to the neutral position to allow the pawl to return to the ratchet holding position. The power release gear can further be provided to rotate from the neutral position in the second direction to cause the lug to move the link member from the decoupled position to the coupled position with the actuator output lever to move the override release mechanism to the engaged position.

According to another aspect of the present disclosure, the override release mechanism can include a release lever operably connected with the at least one of an inside door handle and an outside door handle and a link member configured for movement in response to movement of the release lever, with the link member being moveable to a decoupled position relative to the actuator output lever to maintain the override release mechanism in the disengaged position and to a coupled position relative to the actuator output lever to move the override release mechanism to the engaged position.

According to another aspect of the present disclosure, the link member can be operably connected to the release lever by a pin fixed to the link member, wherein the pin is configured for relative movement with the actuator output lever between the decoupled position and the coupled position.

According to another aspect of the present disclosure, the actuator output lever can be provided having a channel and a drive shoulder, with the pin being configured for relative movement with the actuator output lever while in the channel and being configured for conjoint movement with the actuator output lever while in engagement with the shoulder.

According to another aspect of the present disclosure, the latch assembly can further include an unlock lever configured for operable communication with the link member and a lug configured for conjoint rotation with the power release gear. The lug can be configured for engagement with the unlock lever upon rotating the power release gear in a first direction to bring the unlock lever into driving engagement with the link member to move the link member from the decoupled position to the coupled position.

According to another aspect of the present disclosure, the lug can be configured for engagement with the unlock lever upon rotating the power release gear being moved in a second direction opposite the first direction to bring the unlock lever into driving engagement with the link member to move the link member from the coupled position to the decoupled position.

According to another aspect of the present disclosure, the unlock lever can be configured for rotation about a common axis with the power release gear, thereby facilitating ease of actuation while minimizing the number of components and size of the latch assembly.

According to another aspect of the present disclosure, the latch assembly can include a biasing member configured to impart a bias on the unlock lever to releasably maintain the link member in each of the coupled position and the decoupled position.

According to another aspect of the present disclosure, the lug imparts a bias on the unlock lever during rotation of the power release gear in the first and second directions to overcome the bias imparted by the biasing member on the unlock lever to toggle the unlock lever between locked and unlocked positions.

According to another aspect of the present disclosure, the power latch assembly can be provided to include a control unit in electrical communication with the motor, with the control unit being configured in electrical communication with at least one sensor configured to detect a crash condition, wherein the control unit automatically energizes the motor in response to a detected crash condition to move the power release gear from the neutral position in the second direction to the to cause the lug to move the link member from the decoupled position to the coupled position with the actuator output lever to move the release mechanism to the engaged position.

According to another aspect of the present disclosure, the release lever can be provided having a slot and the pin can extend through the slot, with the pin being configured for sliding translation in the slot when the link member moves between the decoupled position and the coupled position.

According to another aspect of the present disclosure, the unlock lever can be provided having a slot configured for receipt of a pin extending from a first side of the link member therein, wherein the pin is configured to translate in the slot in response to movement of the release lever.

According to another aspect of the present disclosure, the actuator output lever can be provided having a channel and a drive shoulder, and wherein the link member is provided with a drive lug extending from a second side of the link member opposite the first side of the link member from which the pin extends, with the drive lug being configured for relative movement with the actuator output lever while in the channel and being configured for conjoint movement with the actuator output lever while in engagement with the shoulder.

According to another aspect of the present disclosure, the release lever can be provided with a slot, with the pin extending through the slot, wherein the unlock lever drives the pin in sliding translation in the slot in response to movement of the power release gear in a first direction to bring the drive lug into confronting relation with the shoulder, and wherein the unlock lever drives the pin in sliding translation in the slot in response to movement of the power release gear in the second direction to bring the drive lug into alignment with the channel.

According to another aspect of the present disclosure, there is provided a method of operating a power latch assembly for a vehicle door, the method including the steps of operating a prime mover configured to control powered actuation of a power release actuator system comprising a pawl and a ratchet during a normal mode of the power latch assembly to move the pawl from a ratchet holding position to a ratchet releasing position and to maintain an override release mechanism in a disengaged state, whereat the override release mechanism operably decouples at least one of an inside door handle and an outside door handle from the pawl.

According to yet another aspect of the present disclosure, the method of operating a power latch assembly can include operating the prime mover during a manual mode of the power latch assembly to transition the override release mechanism to an engaged state whereat the override release mechanism operably couples at least one of the inside door handle and the outside door handle with the pawl.

According to yet another aspect of the present disclosure, there is provided a power latch assembly for a vehicle door, including a ratchet configured for movement between a striker capture position and a striker release position and being biased toward the striker release position, a pawl configured for movement between a ratchet holding position whereat the pawl maintains the ratchet in the striker capture position and a ratchet releasing position whereat the pawl releases the ratchet for movement of the ratchet to the striker release position, an override release mechanism configured for mechanical actuation by at least one of an inside door handle and an outside door handle and being moveable between a disengaged state, whereat the override release mechanism is disengaged from operable communication with the pawl, and an engaged state, whereat the override release mechanism is engaged in operable communication with the pawl, a prime mover configured to control powered actuation of the pawl release lever to move the pawl from the ratchet holding position to the ratchet releasing position and to maintain the override release mechanism in the disengaged state during normal operation of the power latch assembly and to selectively move the override release mechanism to the engaged state, and a controller configured to control activation of the prime mover in response to determining an operating mode of the power latch assembly.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a partial perspective view of a motor vehicle having a side door equipped with a power latch assembly embodying the teachings of the present disclosure;

FIG. 2A is a schematic view of a power latch assembly and latch system therewith embodying the teachings of the present disclosure, with some components removed for clarity purposes only;

FIG. 2B is a perspective view of a power latch assembly embodying the teachings of the present disclosure, with some components removed for clarity purposes only;

FIGS. 3A and 3B illustrate opposite side views of a portion of the power latch assembly of FIG. 2B while in a home position showing a mechanical override system embodying the teachings of the present disclosure in a mechanically disengaged position, with some components removed for clarity purposes only;

FIG. 3C illustrates an exploded perspective view of various components of the mechanical override system of FIG. 3 while in the mechanically disengaged position;

FIGS. 4A and 4B are similar to FIGS. 3A and 3B, respectively, showing the latch assembly in a power release, actuated position with the mechanical override system in the mechanically disengaged position;

FIGS. 5A and 5B are similar views to FIGS. 3A and 3B, respectively, with the latch assembly reset to the home position with the mechanical override system in the mechanically disengaged position;

FIGS. 6A and 6B are similar views to FIGS. 3A and 3B, respectively, with the mechanical override system shown in the mechanically disengaged position while an inside handle of the side door is actuated;

FIGS. 7A and 7B are similar views to FIGS. 6A and 6B, respectively, with the mechanical override system shown in the mechanically disengaged position while the inside handle has been released to a rest position;

FIGS. 8A and 8B are similar views to FIGS. 3A and 3B, respectively, showing the latch assembly in a power actuated position with the mechanical override system shown in a mechanically engaged position;

FIG. 8C illustrates an exploded perspective view of various components of the mechanical override system of FIG. 3 while in the mechanically engaged position;

FIGS. 9A and 9B are similar to FIGS. 8A and 8B, respectively, with the mechanical override system shown in the mechanically engaged position while mechanically actuated by the inside handle;

FIGS. 10A and 10B are similar to FIGS. 9A and 9B, respectively, while the inside handle has been release to the rest position;

FIGS. 11A and 11B are similar to FIGS. 9A and 9B, respectively, showing the latch assembly in the power release, actuated position with the mechanical override system shown automatically returned to the mechanically disengaged position;

FIGS. 12A and 12B are similar to FIGS. 11A and 11B, respectively, showing the latch assembly reset to the home position with the mechanical override system reset in the mechanically disengaged position;

FIG. 13 is a block diagram of an electronic control circuit of the power latch assembly of FIG. 1, in accordance with an illustrative embodiment;

FIGS. 14A and 14B are system diagrams of the power latch assembly of FIG. 1 operating in a normal mode and a manual mode, respectively, in accordance with an illustrative embodiment;

FIG. 15 is a flow chart relating to a mode-management procedure implemented in the electronic control circuit of FIG. 10, in accordance with an illustrative embodiment;

FIG. 16 is a method of operating the power latch assembly of FIG. 1, in accordance with an illustrative embodiment;

FIG. 17 is a perspective view of another power latch assembly embodying the teachings of the present disclosure, with some components removed for clarity purposes only;

FIG. 18A is an exploded perspective view of various components of the power latch assembly of FIG. 17 shown while in a mechanically engaged position;

FIG. 18B is a view similar to FIG. 18a with the power latch assembly of FIG. 17 shown while in a mechanically disengaged position;

FIGS. 19A and 19B illustrate opposite side views of a portion of the power latch assembly of FIG. 17 while in a home position showing a mechanical override system embodying the teachings of the present disclosure in a mechanically engaged position, with some components removed for clarity purposes only;

FIGS. 20A and 20B are similar to FIGS. 19A and 19B, respectively, showing the latch assembly in a power release, actuated position with the mechanical override system in the mechanically engaged position;

FIGS. 21A and 21B are similar views to FIGS. 19A and 19B, respectively, with the latch assembly reset to the home position with the mechanical override system in the mechanically engaged position;

FIGS. 22A and 22B are similar views to FIGS. 19A and 19B, respectively, with the mechanical override system shown in the mechanically engaged position while an inside handle of the side door is actuated;

FIGS. 23A and 23B are similar views to FIGS. 22A and 22B, respectively, with the mechanical override system shown in the mechanically engaged position while the inside handle has been released to a rest position;

FIGS. 24A and 24B are similar views to FIGS. 22A and 22B, respectively, with the mechanical override system shown in the mechanically disengaged position while an inside handle of the side door is in the rest position;

FIGS. 25A and 25B are similar views to FIGS. 24A and 24B, respectively, with the mechanical override system shown in the mechanically disengaged position while an inside handle of the side door is actuated;

FIGS. 26A and 26B are similar views to FIGS. 25A and 25B, respectively, with the mechanical override system shown in the mechanically engaged position while the inside handle has been released to a rest position;

FIGS. 27A and 27B are similar to FIGS. 26A and 26B, respectively, showing the latch assembly reset to the home position with the mechanical override system automatically reset in the mechanically disengaged position;

FIGS. 28A and 28B illustrate a double actuation mechanism in accordance with another aspect of the disclosure, wherein the double actuation mechanism requires at least two deliberate actions to mechanically release a door of a motor vehicle via an inside door handle; and

FIG. 29 is a flow diagram illustrating steps of a double actuation mechanism for mechanically opening a door of a motor vehicle.

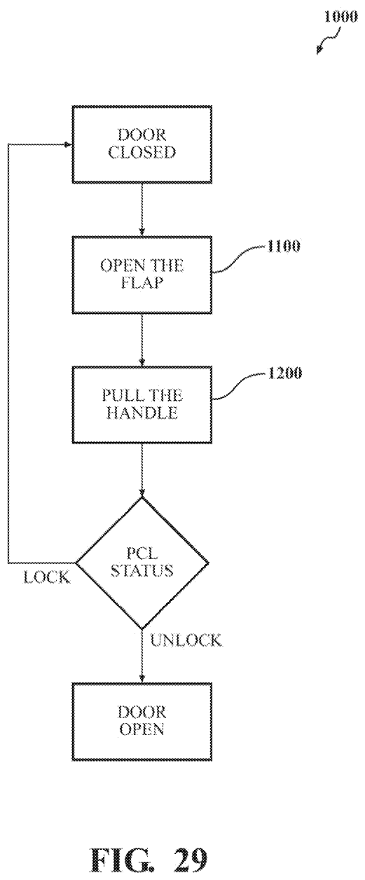

Corresponding reference numerals are used throughout all of the drawings to indicate corresponding parts.

### DETAILED DESCRIPTION OF EXAMPLE EMBODIMENTS

One or more example embodiments of a latch assembly of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

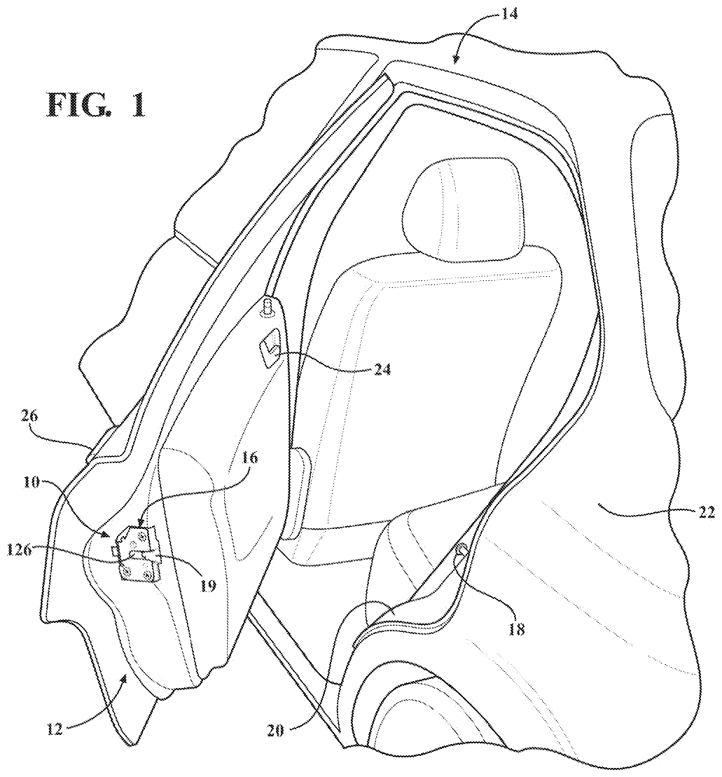

Referring initially to FIG. 1, a non-limiting example of a power latch assembly, referred to hereafter simply as latch assembly 10, and a latch system 11 therewith, installed in a closure panel, such as, by way of example and without limitation, a passenger side swing door 12 of a motor vehicle 14, is shown. Latch assembly 10 includes a latch mechanism 16 configured to releasably latch and hold a striker 18 mounted to a fixed sill portion 20 of vehicle body 22 when swing door 12 is closed. Latch assembly 10 can be selectively actuated via an inside door handle 24, an outside door handle 26, and a key fob 28. As will be detailed, latch assembly 10 is configured to be power-operated in a normal use state and under normal conditions, with inside door handle 24 remaining mechanically disengaged while in a child lock state and outside door handle 26 remaining mechanically disengaged during normal use conditions, such that the inside door handle 24 and outside door handle 26 are normally ineffective for mechanical actuation of latch mechanism 16 during a child lock state and while in normal use. However, the inside door handle 24 can be selectively mechanically coupled with latch mechanism 16, such as via selective actuation by a vehicle driver or occupant having access to an actuation device (not shown), e.g. button in proximity to the vehicle driver, as may be desired to override the child lock state of a rear passenger door, by way of example and without limitation, and inside door handle 24 and outside door handle 26 can be configured to be automatically mechanically coupled with latch mechanism 16 in a crash condition via a mechanical override release system, referred to hereafter as override release mechanism or release mechanism 29, such that latch mechanism 16 can be manually and mechanically actuated via inside door handle 24 and outside door handle 26, when desired, and thereafter, inside door handle 24 and outside door handle 26 can be selectively and automatically returned to their respective normal use positions, as discussed in further detail below.

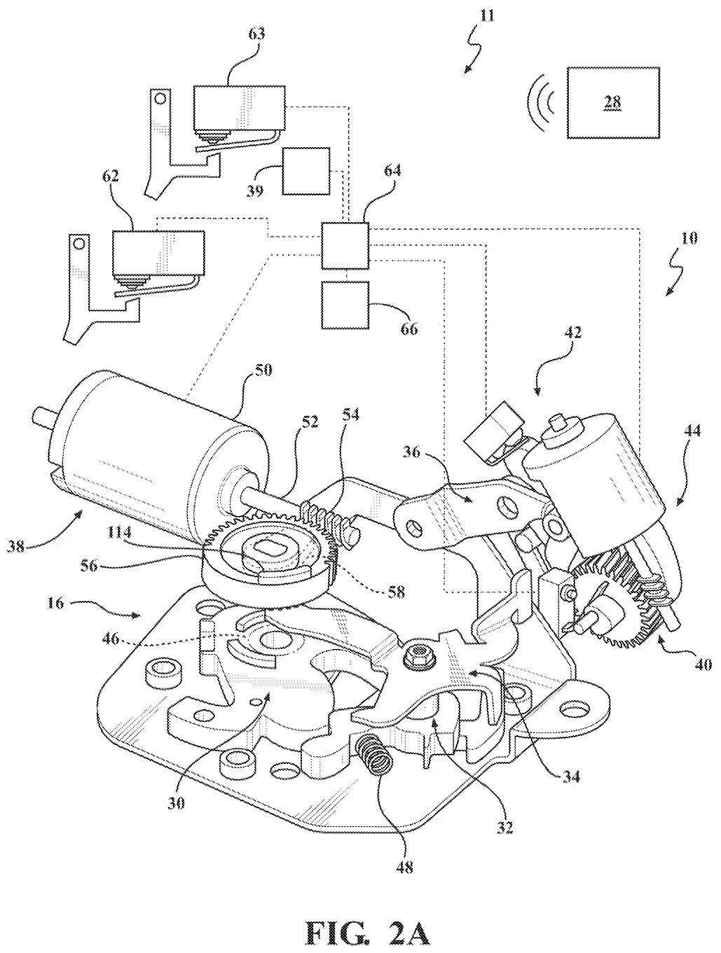

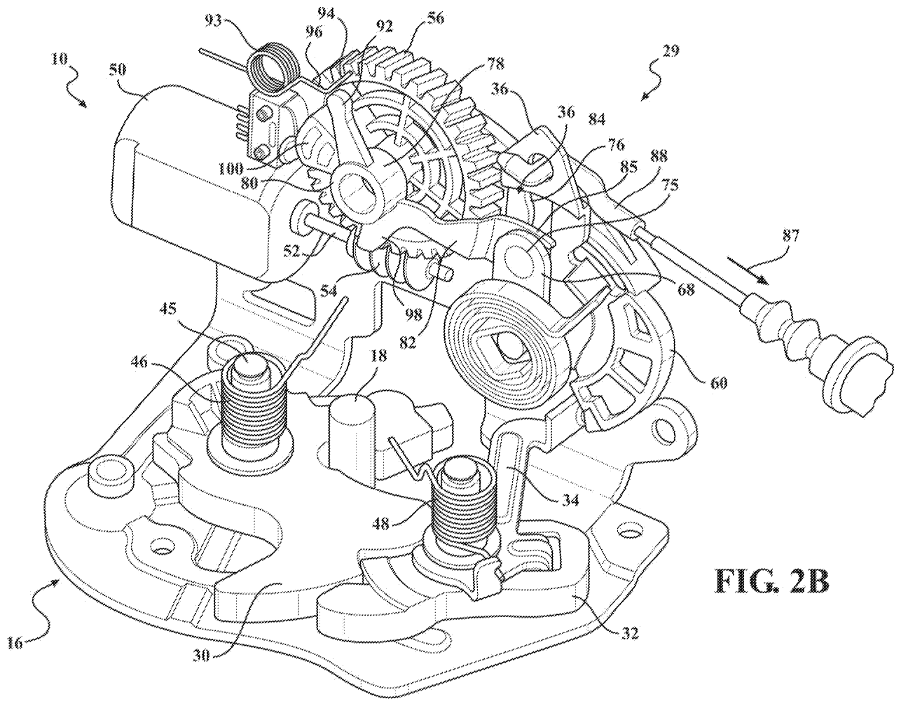

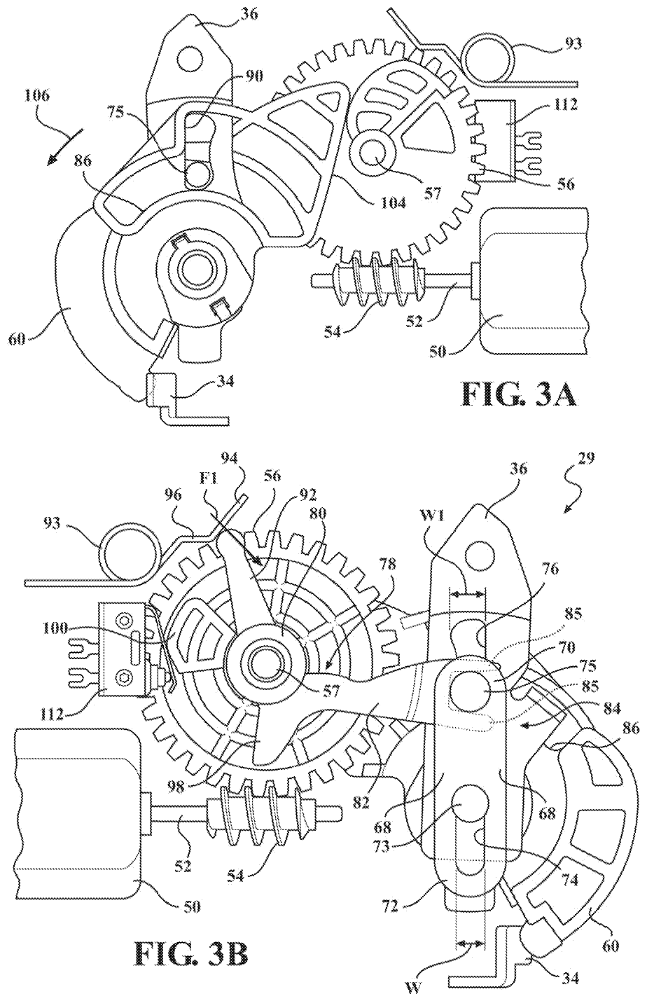

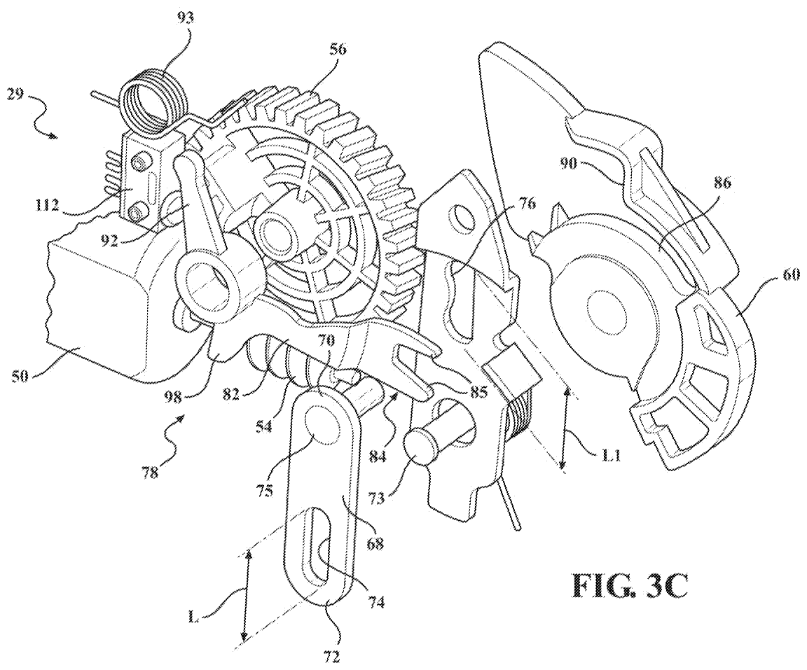

Referring to FIG. 2A, shown is a non-limiting embodiment of latch system 11, latch assembly 10 and latch mechanism 16, with some components, discussed below, removed for clarity purposes, having a ratchet 30 and a pawl 32, a latch release mechanism having a pawl release lever 34, an inside door release mechanism and an outside door release mechanism having an inside and/or outside release lever, referred to hereafter simply as release lever 36, by way of example and without limitation, operably connected to inside door handle 24 and/or outside door handle 26 for selective mechanical operation, a power release actuator system 38 for controlling powered actuation of the latch release mechanism 16 and the override release mechanism 29, and a power lock actuator 40 having a lock mechanism 42 and an electric lock motor 44. Ratchet 30 is supported for rotation on a ratchet rivet or pin 45 for movement between a striker capture position (shown in FIGS. 2A and 3) whereat ratchet 30 retains striker 18 and swing door 12 in closed position, and a striker release position (FIG. 1) whereat ratchet 30 permits release of striker 18 from a fishmouth 19 provided by a latch housing of latch assembly 10 to allow movement of swing door 12 to the open position. A ratchet biasing member 46, such as a spring, is supported on ratchet pin 45 to normally bias ratchet 30 toward its striker release position. Pawl 32 is movable between a ratchet holding position whereat pawl 32 holds ratchet 30 in its striker capture position, and a ratchet releasing position whereat pawl 32 permits ratchet 30 to move to its striker release position. A pawl biasing member 48, such as a suitable spring, is provided to normally bias pawl 32 toward its ratchet holding position.

Pawl release lever 34 is operatively connected to pawl 32 and is movable between a pawl release position whereat pawl release lever 34 moves pawl 32 to its ratchet releasing position, and a home position whereat pawl release lever 34 permits pawl 32 to be in its ratchet holding position. A release lever biasing member (not shown), such as a suitable spring, can be provided to normally bias pawl release lever 34 toward its home position. Pawl release lever 34 can be moved to its pawl release position by several components, such as, for example, by power release actuator system 38 and by release lever 36.

Power release actuator system 38 includes a prime mover, shown as being provided by an electrically actuatable motor, referred to as power release motor 50, having an output shaft 52, with a drive gear, also referred to as power release gear, shown as a power release worm gear 54 mounted on output shaft 52, by way of example and without limitation, and a power release gear 56. A power release cam 58 is connected for conjoint rotation with power release gear 56 about a release gear pin 57 and is rotatable between a pawl release range of positions and a pawl non-release range of positions. In FIG. 2A, power release cam 58 is located in a position that is within the pawl non-release range. Power release gear 56 is driven by power release worm gear 54 for driving power release cam 58 which, in turn, drives an actuator output lever 60 (FIGS. 3A-11B) which drives pawl release lever 34 from its home position into its pawl release position.

Power release actuator system 38 can be used as part of a conventional passive keyless entry feature. When a person approaches vehicle 14 with electronic key fob 28 (FIG. 2A) and actuates the outside door handle 26, for example, sensing both the presence of key fob 28 and that outside door handle 26 has been actuated (e.g. via electronic communication between an electronic switch 62 (FIG. 2A, wherein inside door handle 24 also is actuatable via an electronic switch 63) and a latch electronic control unit (ECU) shown at 64 that at least partially controls the operation of latch assembly 10). In turn, latch ECU 64 actuates power release actuator system 38 to cause the actuator output lever 60 to release the latch mechanism 16 and shift latch assembly 10 into an unlatched operating state so as to facilitate subsequent opening of vehicle swing door 12. Power release actuator system 38 can be alternatively activated as part of a proximity sensor based entry feature (radar based proximity detection for example), for example when a person approaches vehicle 14 with electronic key fob 28 (FIG. 2A) and actuates a proximity sensor 66, such as a capacitive sensor, or other touch/touchless based sensor (based on a recognition of the proximity of an object, such as the touch/swipe/hover/gesture or a hand or finger), (e.g. via communication between the proximity sensor 66 and latch ECU 64 that at least partially controls the operation of latch assembly 10). In turn, if detecting a normal use condition, such as the presence of electronic key fob 28, by way of example and without limitation, latch ECU 64 actuates power release actuator system 38 to release the latch mechanism 16 and shift latch assembly 10 into an unlatched operating state so as to facilitate subsequent opening of vehicle door 12, as discussed above. Further, if detecting an other than normal use condition, such as an intentional selective override of a child latch state and/or a crash condition, latch ECU 64 actuates power release motor 50 of power release actuator system 38 to bring inside door handle 24 and outside door handle 26 into mechanically connected relation with actuator output lever 60, thereby allowing mechanical actuation of inside door handle 24 and outside door handle 26 to release the latch mechanism 16 and shift latch assembly 10 into an unlatched operating state so as to facilitate subsequent opening of vehicle door 12.

Referring in more detail to the mechanical override system 29, a plurality of members are brought into selective communication to allow selective mechanical actuation of inside door handle 24, such as when a child lock state has been intentionally unlocked/disengaged or when a double lock state has been unlocked/disabled, and to automatically allow mechanical actuation of inside door handle 24 and/or outside door handle 26, such as upon a crash condition. In normal use conditions (i.e., the car is in a normal driving condition and not in a crash condition), and while the child lock state is locked/engaged, inside and outside door handles 24, 26 are in an operably, mechanically disconnected state from actuator output lever 60, and thus, mechanical actuation of the inside and outside door handles 24, 26 does not cause pawl release lever 34 to move pawl 32 to its ratchet releasing position. Accordingly, the pawl 32 remains in its ratchet holding position regardless of actuation of inside and outside door handles 24, 26. However, if the child lock has been selectively disengaged, as discussed above, such as via an electrically actuatable button or other electrically actuatable device, mechanical override system 29 moves an inside and/or outside unlock link member 68, into alignment for engagement with actuator output lever, also referred to as actuator lever 60, thereby allowing mechanical actuation of the inside and/or outside door handle 24, 26 to cause actuating movement of release lever 36 to drive pawl release lever 34 to move pawl 32 to its ratchet releasing position. Accordingly, the pawl 32 moves to its ratchet releasing position, thereby allowing swing door 12 to be opened via pure mechanical actuation. Similarly, if the motor vehicle 14 has been involved in a crash, mechanical override system 29 is signaled, via aforementioned sensors/detection systems such as a body control module (BCM) 39, to automatically move link member 68 from a disengaged, also referred to as decoupled state or position (disengaged/decoupled state or position), to an engaged, also referred to as coupled state or position (engaged/coupled state or position), whereat link member 68 is brought into alignment for engagement with actuator output lever 60, thereby allowing mechanical actuation of the inside and/or outside door handle 24, 26 to cause pawl release lever 36 to drive release lever 34 to move pawl 32 to its ratchet releasing position. Accordingly, the pawl 32 moves via pure mechanical actuation of inside and/or outside door handle 24, 26 to its ratchet releasing position, thereby allowing swing door 12 to be opened.

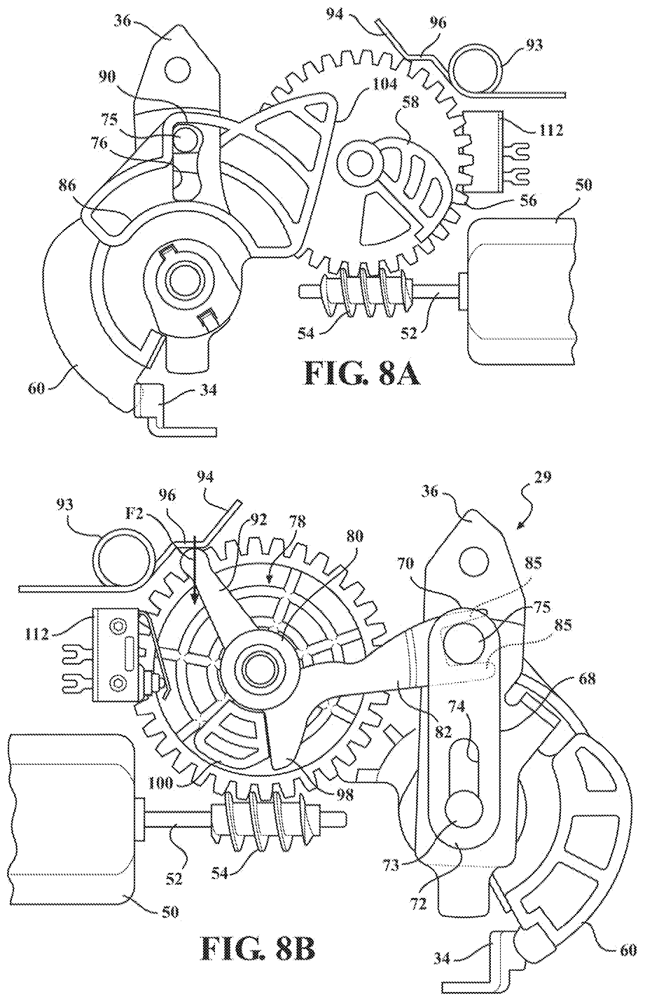

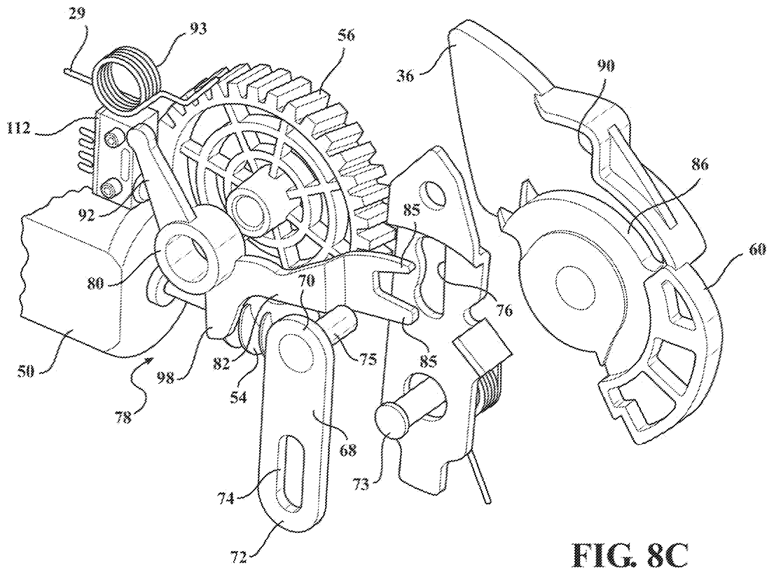

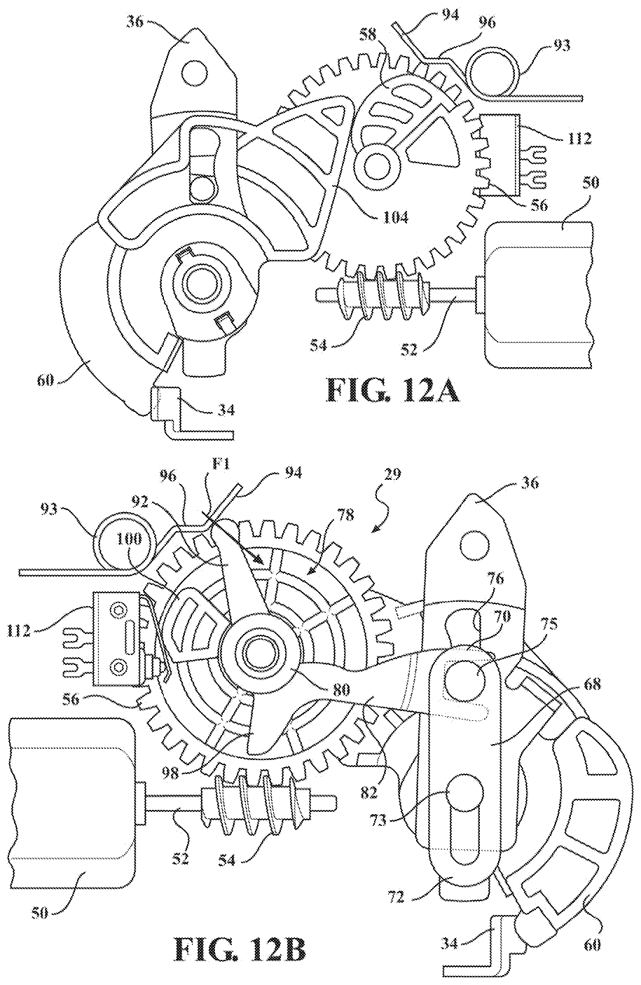

Referring to FIG. 3, link member 68 has a first end 70 operably coupled to release lever 36 for selective, automated movement between an engaged state and a disengaged state, and has a second end 72 pivotably coupled to actuator lever 60. The second end 72 is shown pivotally supported by a first pin 73 also supporting release lever 36 and actuator lever 60 for rotation thereabout. Accordingly, first pin 73 serves as a common axis of rotation for release lever 36, actuator lever 60 and link member 68. First pin 73 is shown as extending within an elongate slot 74 of link member 68, wherein slot 74 has a width W (FIG. 3B) preventing lateral play with first pin 73, such that width W establishes a line-to-line or slightly loose fit with an outer diameter of first pin 73. In contrast, the length L (FIG. 3C) of slot 74 allows link member 68 to translate relative to first pin 73 from a disengaged position (FIGS. 3A-7B and 11A-12B) to an engaged position (FIGS. 8A-10B). First end 70 of link member 68 is coupled to release lever 36 by a second pin 75. Second pin 75 is fixed against relative movement with link member 68 and extends into an elongate slot 76 of release lever 36. Slot 76 has a width W1 (FIG. 3B) preventing lateral play with second pin 75, such that width W1 establishes a line-to-line or slightly loose fit with an outer diameter of second pin 75. In contrast, the length L1 (FIG. 3C) of slot 76 allows second pin 75 to translate therein. Length L1 can be the same as length L of the link member slot 68, such that when first pin 73 is at one end of link member slot 74, second pin 75 is at one end of release lever slot 68, and when first pin 73 is at another end of link member slot 74, second pin 75 is at another end of release lever slot 68, thereby allowing link member 68 to translate relative to release lever 36 between its disengaged/decoupled and engage/coupled positions with actuator lever 60.

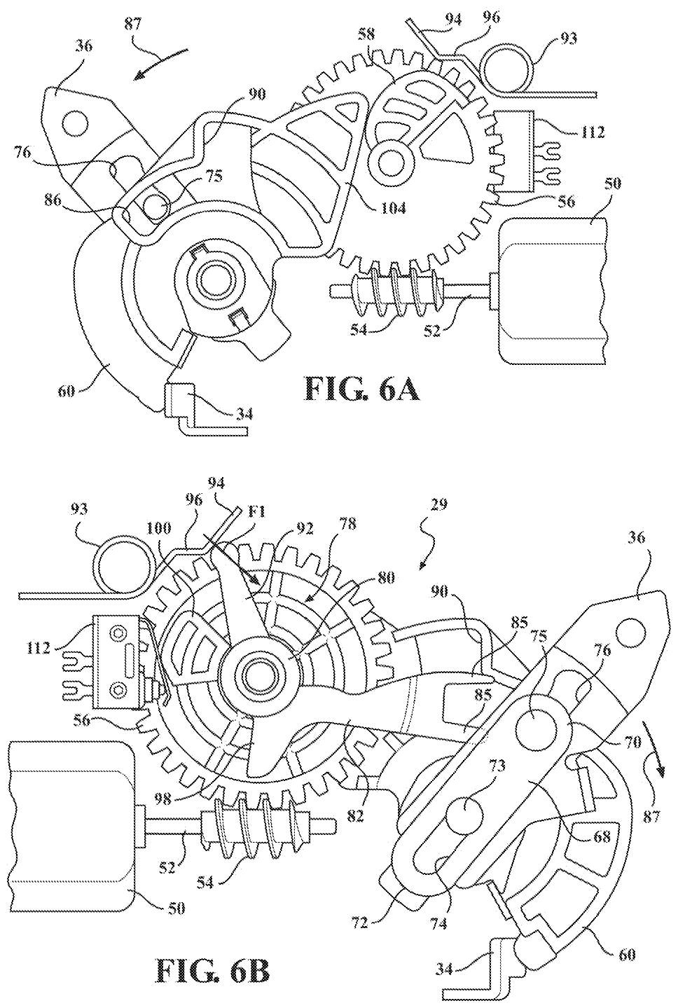

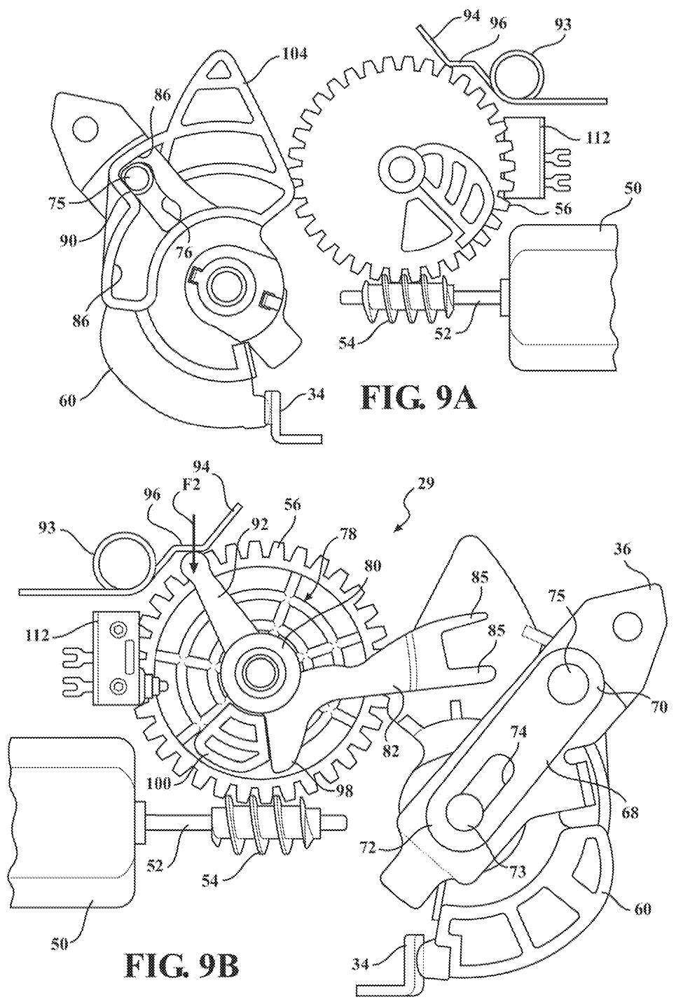

Movement of the link member 68 between its disengaged/decoupled and engaged/coupled states is facilitated by selective movement of an interlink lever, also referred to as unlock lever 78. Unlock lever 78 has a hub 80 that is supported for selective rotation about release gear pin 57. Unlock lever 78 has a first arm 82 extending from hub 80 to a connection end 84 configured for driving engagement with second pin 75 fixed to link member 68. Connection end 84 is shown as having bifurcated fingers 85 forming a recessed cavity sized for close sliding receipt of second pin 75 therein, with each finger 85 extending over opposite sides of second pin 75. When link member 68 is in its disengaged/decoupled state (FIGS. 3A-7B, second pin 75 is aligned for sliding movement within a slot, also referred to as channel 86, of actuator lever 60. Thus, pivotal movement of link lever 68 in the direction of arrow 87 (FIGS. 6A and 6B) in response to mechanical actuation of inside/outside door handles 24, 26, such as via movement in direction 87 of a Bowden cable 88 (FIG. 2B), while link member 68 is in the disengaged/decoupled state does not allow second pin 75 to engage a drive member, shown as a shoulder and also referred to as drive shoulder 90, during mechanical actuation of inside/outside door handles 24, 26, and thus, second pin 75 moves freely in unobstructed fashion through channel 86, thereby not causing actuator lever 60 to move, whereby pawl 32 is maintained in the ratchet holding position, thereby maintaining swing door 12 in the closed position. When link member 68 is selectively moved, such as by being translated along a generally straight path, into its engaged/coupled state (FIGS. 8A-9B) via command by ECU 64, such as when child lock is disengaged or during and upon a crash condition, as discussed above, the second pin 75 is brought into an aligned, confronting position relative to drive shoulder 90 such that movement of link member 68 in the direction of arrow 87, in response to mechanical actuation of either the inside or outside door handles 24, 26 while link member 68 is in the engaged/coupled state, causes second pin 75 to engage drive shoulder 90, thereby rotatably driving actuator output lever 60 and driving pawl 32 to its ratchet releasing position, thus allowing swing door 12 to be opened. Unlock lever 78 is shown to be positioned adjacent to power release gear 56 in a different plane. In the illustrative example, unlock lever 78 and power release gear 56 are positioned about a common axis and are co-axial providing a compact space saving arrangement.

Unlock lever 78 further includes a biasing arm, also referred to as second arm 92, configured to facilitate, in conjunction with a biasing member, such as a spring member, referred to hereafter as toggle spring 93, releasably maintaining unlock lever 78 in the desired engaged/coupled and disengaged/decoupled position. Second arm 92 extends outwardly from hub 80 to provide a lever against which toggle spring 93 acts. Toggle spring 93 has a first leg 94 configured to act on and impart a first force F1 on second arm 92 to releasably hold second arm 92 and unlock lever 78 in its disengaged/decoupled position. First force F1 is directed along a first direction on a first side of release gear pin 57 that acts to bias unlock lever 78 in a clockwise (CW) direction, as viewed in FIGS. 3B, 4B, 5B, 6B, 7B, 11B, 12B, thereby biasing and holding link member 68 and second pin 75 fixed thereto, via fingers 85 acting on second pin 75, in the disengaged/decoupled position relative to actuator lever 60. Toggle spring 93 has a second leg 96 configured to act on and impart a second force F2 on second arm 92 to releasably hold second arm 92 and unlock lever 78 in its engaged/coupled position. Second force F2 is directed along a second direction on a second side of release gear pin 57, opposite the first side of release gear pin 57 along which first force F1 is directed, that acts to bias unlock lever 78 in a counterclockwise (CCW) direction, as viewed in FIGS. 8B, 9B, 10B, thereby biasing and holding link member 68 and second pin 75 fixed thereto, via fingers 85 acting on second pin 75, in the engaged/coupled position relative to actuator lever 60. To facilitate toggled movement of unlock lever 78 and second arm 92 thereof relative to toggle spring 93, to move second arm 92 between the first and second legs 94, 96 of toggle spring 93, unlock lever 78 further includes a drivable member, also referred to as protrusion or driven member 98 extending outwardly from hub 80. Driven member 98 is shown as extending outwardly from hub 80 adjacent first arm 82, thereby providing unlock lever 78 with a tri-spoke shape, with first and second arms 82, 92 and driven member 98 extending radially outwardly from hub 80 in generally equistantly spaced relation from one another, such as about 120 degrees spacing therebetween, by way of example and without limitation. First arm 82 and driven member 98 are configured in generally coplanar relation with one another for operable engagement with a drive member 100 of power release gear 54, while second arm is laterally offset out from planar alignment with first leg 82 to allow for the passage of drive member 100 thereby, as discussed below, to selectively and intentionally move unlock lever 78 between its engaged/coupled and disengaged/decoupled positions.

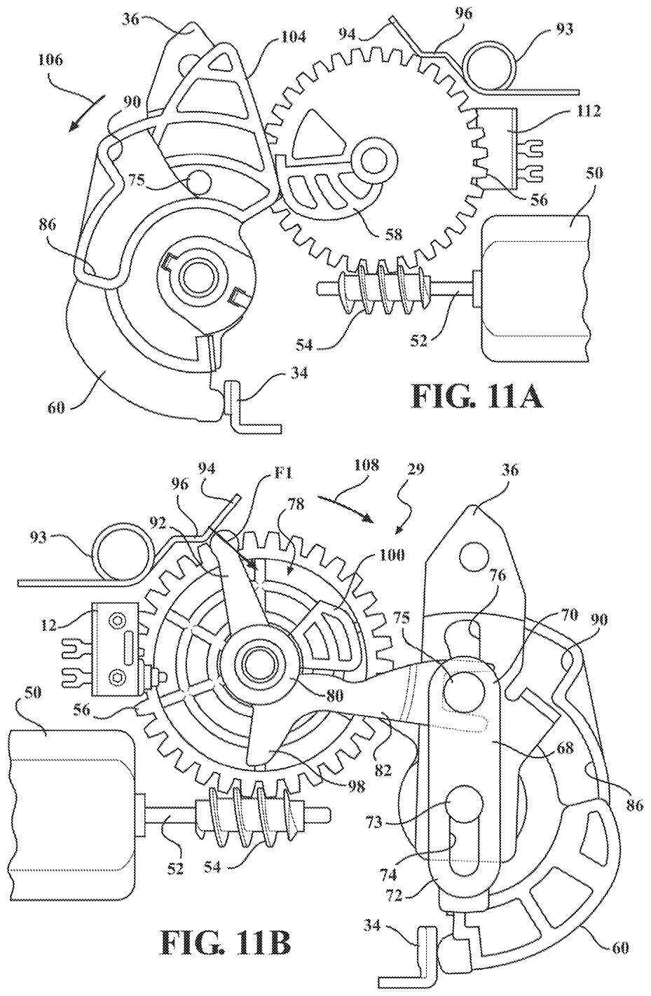

The power release gear 56 has drive member 100, also referred to as lug, configured in coplanar relation with first arm 82 and driven member 98 of unlock lever 78. As such, during intended movement of second arm 92 between first and second legs 94, 96 of toggle spring 93, drive member 100 is aligned for engagement with driven member 98 (FIGS. 8B, 9B, 10B) to move unlock lever 78 from its disengaged/decoupled position to its engaged/coupled position, and drive member 100 is aligned for engagement with first arm 82 (FIG. 11B) to move unlock lever 78 from its engaged/coupled position back to its disengaged/decoupled position. As drive member 100 moves toward first arm 82, drive member 100 passes by second arm 92 in clearance relation therefrom, with second arm 92 being laterally offset from drive member 100, as noted above.

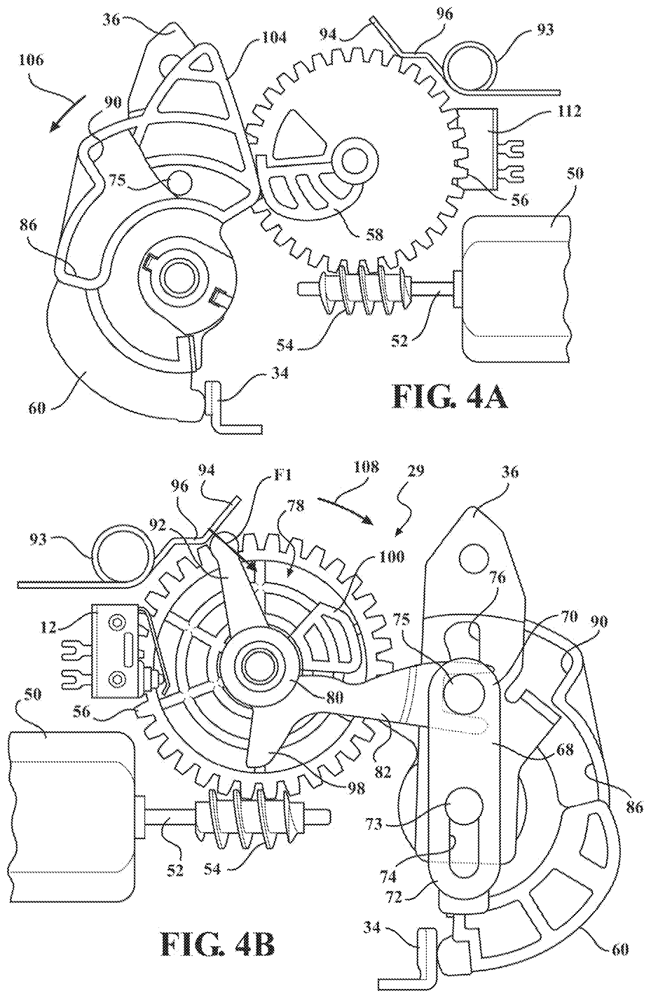

In normal operation, to open the vehicle door 12, the power release motor 50 is commanded via ECU 64 to drive power release worm gear 54 such that it drives power release gear 56 from a start position, also referred to as neutral or home position (FIGS. 2C, 3A and 3B), in a first, counterclockwise direction (as viewed in FIG. 4A) to an unlatched, also referred to as release, position. As power release gear 56 rotates toward a release position, drive cam 58 fixed to power release gear 56 rotates in driving engagement with a driven cam surface 104 of actuator lever 60, thereby causing actuator lever 60 to rotate in the direction of arrow 106 into driving engagement with pawl lever 34, which in turn drives pawl 32 rotatably to its ratchet releasing position, whereupon ratchet 30 rotates under a bias imparted by ratchet biasing member 46 to its striker release position. As shown in FIG. 4B, rotation of power release gear 56 toward its release position causes drive member 100 to rotate in a direction of arrow 108 in bypassing relation with second arm 92 into confronting engagement with first arm 82 of unlock lever 78, with override release mechanism 29 remaining in it disengaged/decoupled position. While power release gear 56 is in the release position illustrated in FIGS. 4A and 4B, swing door 12 is able to be opened.

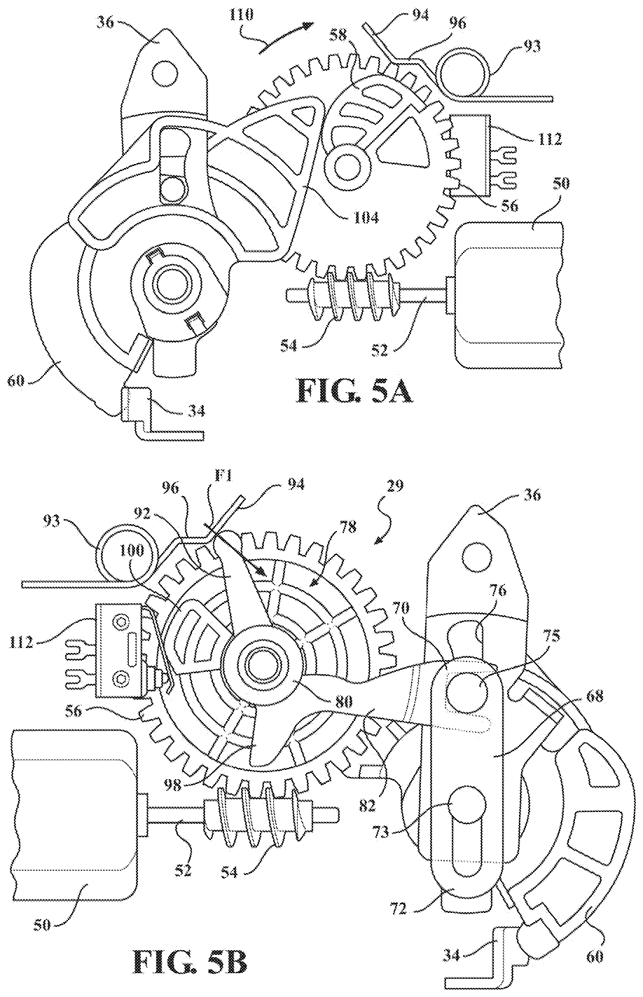

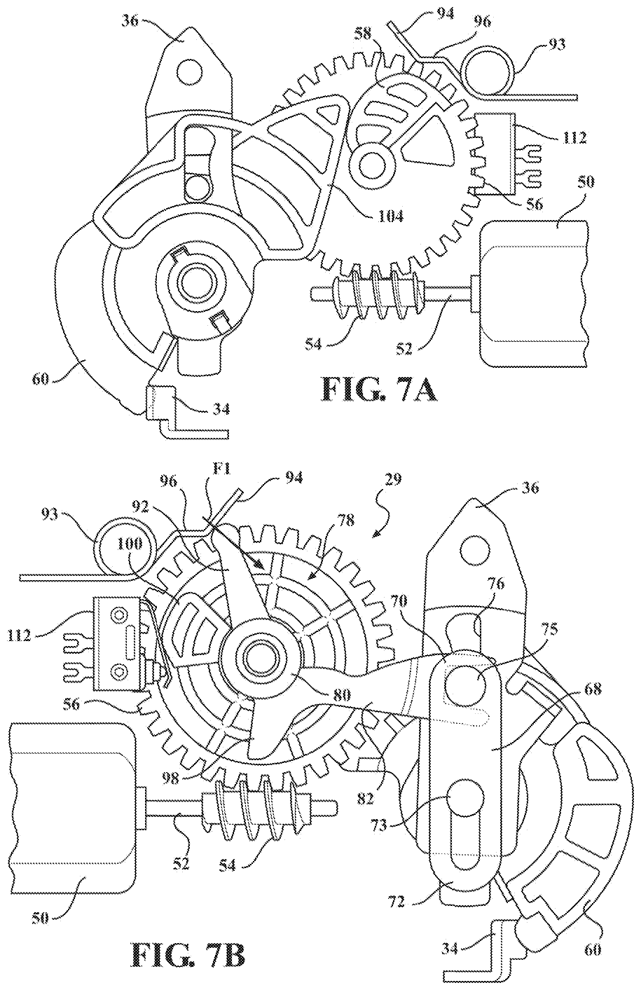

Upon the vehicle door 12 being opened, the power release motor 50 is commanded via ECU 64 of latch system 11 to drive power release worm gear 54 such that it drives power release gear 56 in a second, clockwise direction indicated by arrow 110, as viewed in FIG. 5A, until power release gear 56 reaches its home, rest position, which can be detected by a sensor 112 configured to detect a home position of drive member 100, by way of example and without limitation. As power release gear 56 rotates clockwise, override release mechanism 29 remains in its disengaged/decoupled position via toggle spring 93 maintaining a bias on second arm 92. As shown in FIGS. 6A and 6B, with override release mechanism 29 remaining in its disengaged/decoupled position, actuation of inside and/or outside door handle 24, 26 can cause release lever 36 and link member 68 to be rotated in the direction of arrow 87, but latch mechanism 16 remains in its latched state, thereby preventing swing door 12 from being opened. As link member 68 is rotated, second pin 75 moves outwardly from between fingers 85 and through channel 86 of actuator lever 60. As such, no bias is imparted on actuator lever 60, and thus, actuator lever 60 remains stationary. Accordingly, as referenced above, pawl 32 remains in its ratchet holding position with ratchet 30, and thus, striker 18 remains captured by ratchet 30 while ratchet 30 remains in its striker capture position. In FIGS. 7A and 7B, release lever 36 is shown returned to its home or rest position upon release of the inside and/or outside door handle 24, 26.

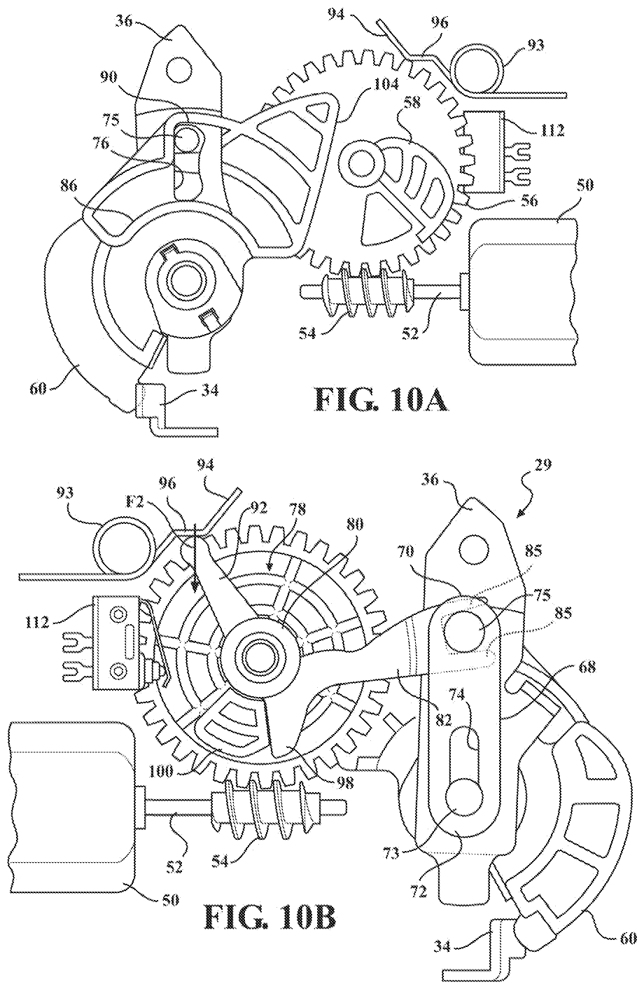

In a crash condition, wherein the following actuation is automated in response to crash detection sensors, such as proximity sensors 66 and the like, or when child lock is selectively disengaged, power release gear 56 is rotatably driven in the second, clockwise direction (as viewed in FIGS. 2C and 8A) via command from ECU 64 to power release motor 50, whereupon drive member 100 on power release gear 56 confronts and drives driven member 98 of unlock lever 78 in a counterclockwise direction, as viewed in FIG. 8B. Rotation of unlock lever 78 in the counterclockwise direction translates link member 68 into its engaged/coupled state, whereat second pin 75 fixed to link member 68 moves into confronting engagement with drive shoulder 90 of actuation lever 60 (best seen in FIG. 8A). Accordingly, engagement of link member 68 only requires unlock lever 78 to be rotatably driven by lug 100 of power release gear 56, thereby providing a relatively simple, compact mechanism for actuating the mechanical release mechanism. As such, actuation of release lever 36 via manual actuation of inside and/or outside door handle 24, 26 drives second pin 75 into driving engagement with drive shoulder 90, thereby causing actuation lever 60 to be driven conjointly with release lever 36. As such, actuation lever 60, as during a normal powered release operation discussed above, drives pawl release lever 34, thereby causing pawl 32 to be moved to its ratchet releasing position, and thus, causing ratchet 30 to move to its striker release position, whereat swing door 12 can be opened. Accordingly, swing door 12 is able to be opened via mechanical operation of inside and outside door handles 24, 26. Then, upon releasing inside and/or outside door handles 24, 26, Bowden cable 88 allows release lever 36 to return to its home, rest position, with link lever 68 returned to a rest position, though remaining in the engaged/coupled position with drive shoulder drive shoulder 90 (FIGS. 10A and 10B). Then, in the next power release operation performed as described above with regard to FIGS. 4A and 4B, rotation of power release gear 56 from its and drive member 100 fixed thereto causes mechanical override system 29 to be automatically reset, such that link lever 68 is automatically returned to its disengaged/decoupled state, where it remains via bias imparted by toggle spring 93 on second arm 92.

As such, latch assembly 10 is configured to be solely power actuated, if desired, while in a normal use state, wherein mechanical movement of inside and outside door handles 24, 26 is inoperable to effect unlatching actuation of the latch assembly 10. Further, latch assembly 10 is configured to be mechanically actuated while a child lock is disengaged and/or upon experiencing a crash condition, wherein mechanical movement of inside and/or outside door handle 24, 26 is operable to effect unlatching actuation of the latch assembly 10. In these embodiments, only one of the handles 24, 26 is shown connected to the release lever 36 via the Bowden cable 88, shown as the inside handle 24, by way of example and without limitation. It is to be recognized, in accordance with the teachings herein, that inside door handle 24 and outside door handle 26 may be both operatively connected to the release lever 36, such as via a splitter mechanism (not shown), such that a movement of either inside and outside handles 24, 26 may be operative to effect unlatching actuation of the latch assembly 10.

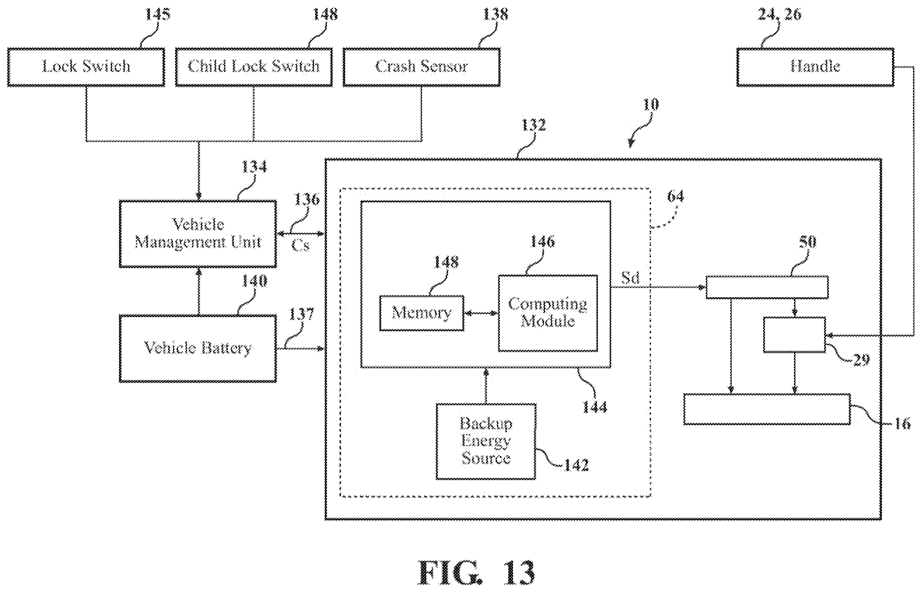

Now referring to FIG. 13, the power latch system 11 and power latch assembly 10 thereof includes the latch electronic control unit (ECU) 64, also referred to as the controller, for example including, as discussed in detail hereinafter, a microcontroller or other known computing unit, which, in a possible embodiment, is conveniently embedded and arranged in a same latch housing or case (shown schematically as 132) together with an power release actuator system 38, thus providing an integrated compact and easy-to-assemble unit. The electronic control unit (ECU) 64 is coupled to the power release actuator system 38 and provides to the prime mover, for example the power release motor 50, suitable driving signals Sd. The electronic control unit (ECU) 64 is electrically coupled to a vehicle management unit 134, which is configured to control general operation of the motor vehicle 14, via an electrical connection element 136, for example a data bus, so as to exchange signals, data, commands and/or information. The vehicle management unit 134 is also coupled to crash sensors 138, for example accelerometer or force sensors, which provide signals, for example acceleration or force signals, which indicate the presence of an emergency situation, such as a crash. Other sensors may be provided to detect the state of the vehicle 14, such as a main battery disconnect sensor (not shown), which may be integrated into vehicle management unit 134. Conveniently, the electronic control unit (ECU) 64 also receives feedback information about the latch actuation from position sensors (such as sensor 112 configured to detect the home position of power release gear 56 via detection of drive member 100, by way of example and without limitation), wherein additional sensors, such as Hall sensors, can be configured to detect the operating position, for example of the ratchet 30 and/or pawl 32; and also receives (directly and/or indirectly via the vehicle management unit 134) information about the actuation of the vehicle (external and/or internal) handles 24, 26 and/or from handle sensors 63, 62, which detect user activation of the internal and/or external handles 24, 26 of the door 12 of the motor vehicle 14. The electronic control unit (ECU) 64 is also coupled to the main power source 140 of the motor vehicle 14, so as to receive the battery voltage Vbatt 137; the electronic control unit (ECU) 64 is able to check if the value of the battery voltage Vbatt decreases below a predetermined threshold value, for example which may indicate a low power condition, a battery disconnect condition, which may in response require the power latch assembly 10 to be transitioned from a normal mode of operation whereby the power release actuator system 38 is electronically controlled for controlling powered actuation of the latch release assembly 10 without the requirement or enablement of a manual activation of external and/or internal handles 24, 26 for controlling the manual actuation of the latch release assembly 10. According to an aspect of the present disclosure, the electronic control unit (ECU) 64 includes an embedded and integrated backup energy source 142, which is configured to supply electrical energy to the prime mover, for example the power release motor 50 and to the same electronic control unit (ECU) 64, in case of failure or interruption of the main power source 140 of the motor vehicle 14. The electronic control unit (ECU) 64 is able to check if the value of the backup energy source voltage Vbackup decreases below a predetermined threshold value. This backup energy source 142 is usually kept in a charged state during normal operation, by the main power source 140, so as to be readily available as soon as the need arises, for example in case of a crash or loss of the main vehicle battery 140. In more details, electronic control unit (ECU) 64 includes a control unit 144, for example provided with a microcontroller, microprocessor or analogous computing module 146, coupled to the backup energy source 142 and the power release motor 50 (providing thereto the driving signal Sd), to control the operation of the power release motor 50. The control unit 144 has an embedded memory 148, for example a non-volatile random access memory, coupled to the computing module 146, storing suitable programs and computer instructions (for example in the form of a firmware). It is recognized that the control unit 144 could alternatively comprise a logical circuit of discrete components to carry out the functions of the computing module 146 and memory 148. The electronic control unit (ECU) 64 is configured to control the latch release assembly 10 for controlling actuation of the door 12, based on signals detected by the handle sensors 63, 62, which are indicative for example of the user intention to power release and open the door 12, and based on signals received from the vehicle management unit 134, which are indicative for example of a correct authentication of the user carrying suitable authentication means (such as in a key fob 28), in a normal mode of operation, and the electronic control unit (ECU) 64 is configured to control the latch release assembly 10 for controlling actuation of the door 12, based a manual actuation by one or both inside and outside handles 24, 26 based on signals received from the vehicle management unit 134, which are indicative for example of a state of the vehicle such as a crash condition, an emergency condition, a low or disconnected power supply condition whereby the power release operation of the latch release assembly 10 is not desired or possible. Furthermore, the electronic control unit (ECU) 64 is configured to control the latch release assembly 10 for controlling a manual actuation of the door 12, based on signals indicating a desired operating condition of the latch release assembly 10, which may include for example a double lock operating state of the latch release assembly 10 controlled by activation of a double lock or lock switch 145 for example provided on the FOB 28, a child lock disabled operating state controlled by activation of a child lock switch 148 whereby a manual activation of the inside door handle 24 will cause the manual activation of the latch release assembly 10.

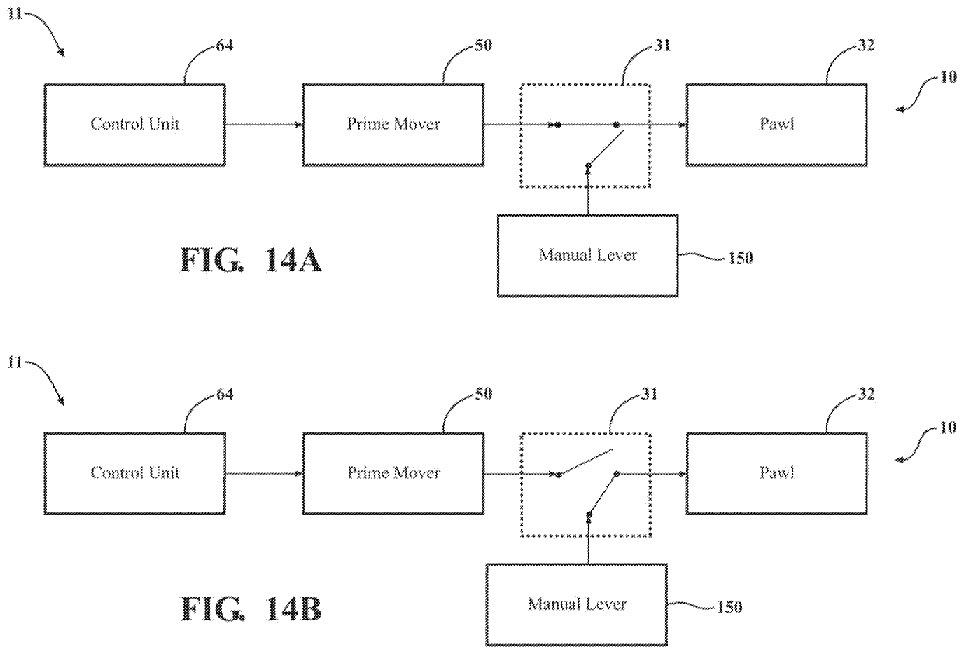

Now referring to FIG. 14A, in accordance with an illustrative embodiment, there is illustrated a system diagram of a power latch system 11 including a power latch assembly 10 for a vehicle door 12 including the ratchet 30 configured for movement between a striker capture position and a striker release position and being biased toward the striker release position, a pawl 32 configured for movement between a ratchet holding position whereat the pawl 32 maintains the ratchet 30 in the striker capture position and a ratchet releasing position whereat the pawl 32 releases the ratchet 30 for movement of the ratchet 30 to the striker release position, an override release mechanism 29 forming part of a bypass assembly 31 configured for mechanical actuation by at least one of an inside door handle 24 and an outside door handle 26 generically referred to as a manually operated lever 150 and which may include a key cylinder as an example, and being moveable between a disengaged state as illustrated in FIG. 14A, whereat the override release mechanism 29 is disengaged from operable communication with the pawl 32 whereby an activation of the manual lever 150 will not cause actuation of the pawl 32 while bypass assembly 31 allows the motor 50 to be operatively coupled to the pawl 32, and an engaged state as illustrated in FIG. 14B, whereat the override release mechanism 29 has transitioned into operable communication with the pawl 32 and bypass assembly 31 operatively decouples the motor 50 from the pawl 32. When in the disengaged state of FIG. 14A, latch assembly 10 is in a normal operating mode and a control of the prime mover 50 will cause a power release of the pawl 32 as described herein above. Prime mover 50 is operatively coupled to the pawl 32 and is configured to move the pawl 32 from the ratchet holding position to the ratchet releasing position and to maintain the override release mechanism 29 in the disengaged position during the normal operation of the power latch assembly 10, and to selectively move the override release mechanism 29 to the engaged position. Controller 64 is provided and configured to control activation of the prime mover 50 in response to determining an operating mode of the power latch assembly 10, for example in response to determining a crash condition, an emergency condition, an insufficient power supply condition or either the main vehicle battery 140 or backup power supply 142, a double lock condition, a child lock condition, and the like without limitation. When in the engaged state of FIG. 14B, latch assembly 10 is in a manual operating mode and a control of the prime mover 50 may not cause a power release of the pawl 32 as described herein above whereas a manual operation of the inside and/or outside handle 24, 26 may cause a manual movement of the pawl 32. It is recognized that during a manual operating mode of the latch assembly 10, latch assembly 10 may be configured to allow a power release of the pawl 32.

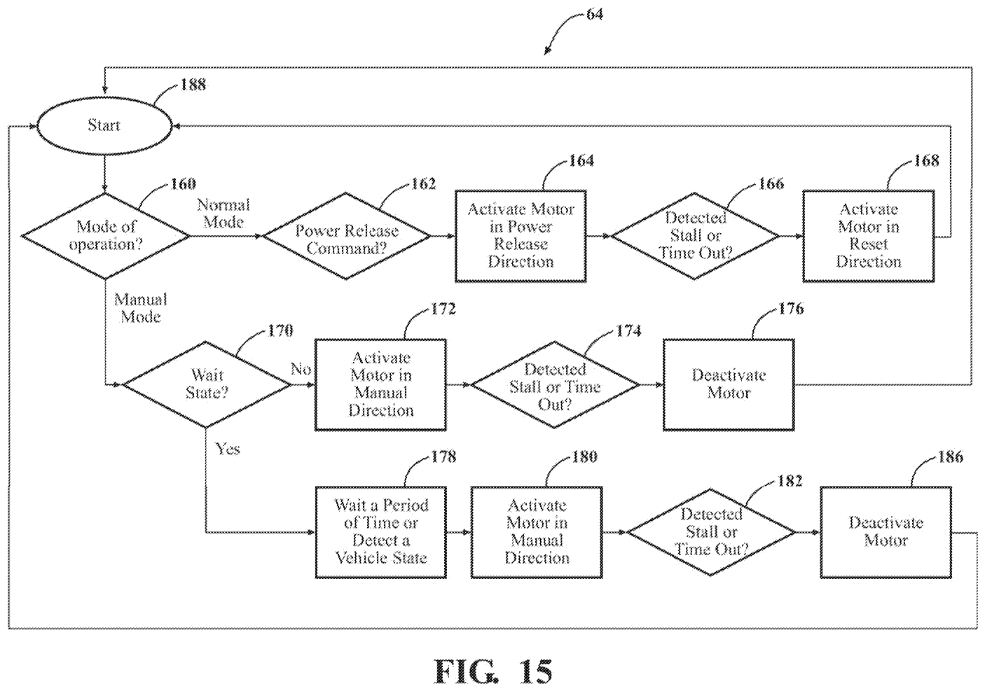

Now referring to FIG. 15, according to an aspect of the present disclosure, the electronic control unit (ECU) 64 is also configured to manage at step 160 the operating mode of the power latch assembly 10 and to implement, locally to the power latch assembly 10, a suitable control algorithm to control the power latch assembly 10, and for example without external intervention by the vehicle management unit 134. The electronic control unit (ECU) 64 may determine a mode of operation, such as for example a normal mode for a power release of the power latch assembly 10 whereby a manual activation of the power latch assembly 10 is not possible, and a manual mode for a manual activation of the power latch assembly 10, whereby a power release of the power latch assembly 10 may or may not be possible. When the electronic control unit (ECU) 64 determines the power latch assembly 10 may operate in a normal mode, electronic control unit (ECU) 64 is responsive at step 162 to a power release command received from the FOB 28, vehicle management unit 134, or one of the sensors 62, 63 to generate and transmit driving signal Sd to activate motor 50 at step 164 in order to cause the pawl 32 to move. At step 166, electronic control unit (ECU) 64 may detect a stall of the motor 50, due to a current spike or as a result of a hall sensor reading or switch activation sensing the position of the power release gear 56, or as a result of a time out period indicating the completion of a power release. At step 168, electronic control unit (ECU) 64 may subsequently generate and transmit driving signal Sd to activate motor 50 in a reset direction, such as a direction opposite the direction of the motor 50 as driven in step 164, or the motor 50 may be further activated in the same direction as driven in step 164. When the electronic control unit (ECU) 64 determines the power latch assembly 10 may operate in a manual mode, electronic control unit (ECU) 64 determines at step 170 if the motor 50 is to be activated immediately, for example when the electronic control unit (ECU) 64 receives a child lock or double lock state disable command, or a power release operation has been determined by the ECU 64 as having failed for example in response to a sensor detecting that pawl 32 has not moved subsequent a powered operation for example, the electronic control unit (ECU) 64 determines vehicle main battery 140 or backup energy supply 142 has drained to a predetermined level, or other malfunction of the release mechanism 18, or if it is required to postpone the activation of motor 50. If at step 170 electronic control unit (ECU) 64 determines the motor 50 is to be activated immediately, at step 172 the electronic control unit (ECU) 64 may subsequently generate and transmit driving signal Sd to activate motor 50 in a reset direction to transition the latch assembly 10 to a state as illustrated in FIGS. 8A and 8B. At step 176 the electronic control unit (ECU) 64 may deactivate motor 50 in response to detecting a stall or end of travel position, or the activation of a switch sensing the position of the power release gear 56 or a time out of a preset period of time at step 174 to maintain the latch assembly 10 in the state as illustrated in FIGS. 8A and 8B. If the electronic control unit (ECU) 64 determines at step 170 based on the type of manual mode, such as based on the crash event or an emergency event, the electronic control unit (ECU) 64 may postpone the activation of motor 50 and at step 178 wait for a period of time after a crash event is detected, or based on the state of the vehicle as detected by an accelerometer indicating the end of a crash event. At step 180 the electronic control unit (ECU) 64 may subsequently generate and transmit driving signal Sd to activate motor 50 in a reset direction to transition the latch assembly 10 to a state as illustrated in FIGS. 8A and 8B. At step 182 the electronic control unit (ECU) 64 may detect a stall or end of travel position of the motor 50 causing a deactivation of motor 50 at step 184 in response to detecting a position of power release gear 56 or a time out of a preset period of time to maintain the latch assembly 10 in the state as illustrated in FIGS. 8A and 8B whereby the override release mechanism 29 is engaged. Electronic control unit (ECU) 64 may at step 188 return to a standby state whereby the override release mechanism 29 returns to a disengaged state as a result of a bias for example acting on the override release mechanism 29, for example as acting indirectly on power release gear 56 or directly on unlock lever 78.

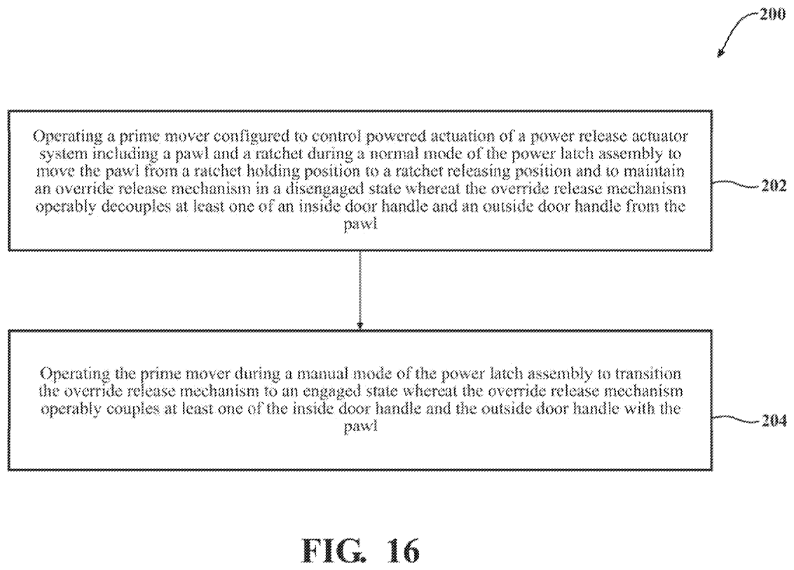

Now referring to FIG. 16, there is illustrated a method 200 of operating the power latch assembly 10, 310 for the vehicle door 12, the method 200 illustratively included a step 202 of operating a prime mover 50, such as configured to control powered actuation of a power release actuator system 38 including a pawl 32 and a ratchet 30 during a normal mode of the power latch assembly 10, 310 to move the pawl 32 from a ratchet holding position to a ratchet releasing position and to maintain an override release mechanism 29, 329 in a disengaged state whereat the override release mechanism 29, 329 operably decouples at least one of an inside release mechanism, such as inside door handle 24, and an outside release mechanism, such as outside door handle 26, from the pawl 32, and a step 204 of operating the prime mover 50 during a manual mode of the power latch assembly 10, 310 to transition the override release mechanism 29, 329 to an engaged state whereat the override release mechanism 29, 329 operably couples at least one of the inside door handle 24 and the outside door handle 26 with the pawl 32. In accordance with an exemplary aspect of the disclosure, the override release mechanism 29, 329 operably couples the inside door handle 24 with the pawl 32, and in accordance with another exemplary embodiment of the disclosure, the override release mechanism 29, 329 operably couples the inside door handle 24 and the outside door handle 26 with the pawl 32.

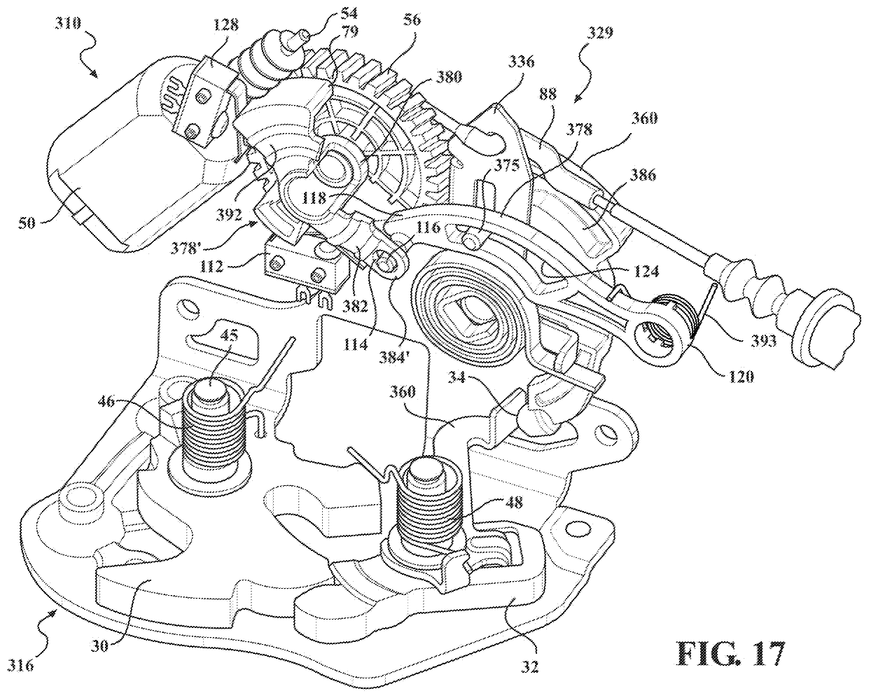

Another non-limiting example of a power latch assembly, referred to hereafter simply as latch assembly 310, is shown in FIG. 17, wherein the same reference numerals as used above for latch assembly 10, offset by a factor of 300, are used to identify like features. Latch assembly 310 is configured for use in a latch system 11, as discussed above for latch assembly 10, installed in a closure panel, such as, by way of example and without limitation, passenger side swing door 12 of motor vehicle 14. Latch assembly 310 includes a latch mechanism 316 configured to releasably latch and hold striker 18 and can be selectively actuated via inside door handle 24, outside door handle 26, and key fob 28, as discussed above for latch assembly 10. As discussed above for latch assembly 10, latch assembly 310 is configured to be power-operated in a normal use state and under normal conditions, with inside door handle 24 remaining mechanically disengaged while in a child lock state and outside door handle 26 remaining mechanically disengaged during normal use conditions, such that the inside door handle 24 and outside door handle 26 are normally ineffective for mechanical actuation of latch mechanism 316 during a child lock state and while in normal use. However, the inside door handle 24 can be selectively mechanically coupled with latch mechanism 316 via a mechanical override release system, referred to as release mechanism 329, such that latch mechanism 316 can be manually and mechanically actuated via inside door handle 24 and outside door handle 26, when desired, and thereafter, inside door handle 24 and outside door handle 26 can be selectively and automatically returned to their respective normal use positions, as discussed in further detail below, as discussed above for latch assembly 10 and release mechanism 29.

Referring in more detail to the mechanical override system 329, a plurality of members are brought into selective communication to allow selective mechanical actuation of inside door handle 24, such as when a child lock state has been intentionally unlocked/disengaged or when a double lock state has been unlocked/disabled, and to automatically allow mechanical actuation of inside door handle 24 and/or outside door handle 26, such as upon a crash condition, as discussed above for mechanical override system 29. In normal use conditions (i.e., the car is in a normal driving condition and not in a crash condition), and while the child lock state is locked/engaged, inside and outside door handles 24, 26 are in an operably, mechanically disconnected state from actuator output lever 360, and thus, mechanical actuation of the inside and outside door handles 24, 26 does not cause pawl release lever 34 to move pawl 32 to its ratchet releasing position. Accordingly, the pawl 32 remains in its ratchet holding position regardless of actuation of inside and outside door handles 24, 26. However, if the child lock has been selectively disengaged, as discussed above, such as via an electrically actuatable button or other electrically actuatable device, mechanical override system 329 moves an inside and/or outside unlock link member 368, into alignment for engagement with actuator output lever, also referred to as actuator lever 360, thereby allowing mechanical actuation of the inside and/or outside door handle 24, 26 to cause actuating movement of release lever 336 to drive pawl release lever 34 to move pawl 32 to its ratchet releasing position. Accordingly, the pawl 32 moves to its ratchet releasing position, thereby allowing swing door 12 to be opened via pure mechanical actuation. Similarly, if the motor vehicle 14 has been involved in a crash, mechanical override system 329 is signaled, via aforementioned sensors/detection systems such as a body control module (BCM) 39, to automatically move link member 368 from a disengaged, also referred to as decoupled state or position (disengaged/decoupled state or position), to an engaged, also referred to as coupled state or position (engaged/coupled state or position), whereat link member 368 is brought into alignment for engagement with actuator output lever 360, thereby allowing mechanical actuation of the inside and/or outside door handle 24, 26 to cause pawl release lever 336 to drive release lever 34 to move pawl 32 to its ratchet releasing position. Accordingly, the pawl 32 moves via pure mechanical actuation of inside and/or outside door handle 24, 26 to its ratchet releasing position, thereby allowing swing door 12 to be opened.

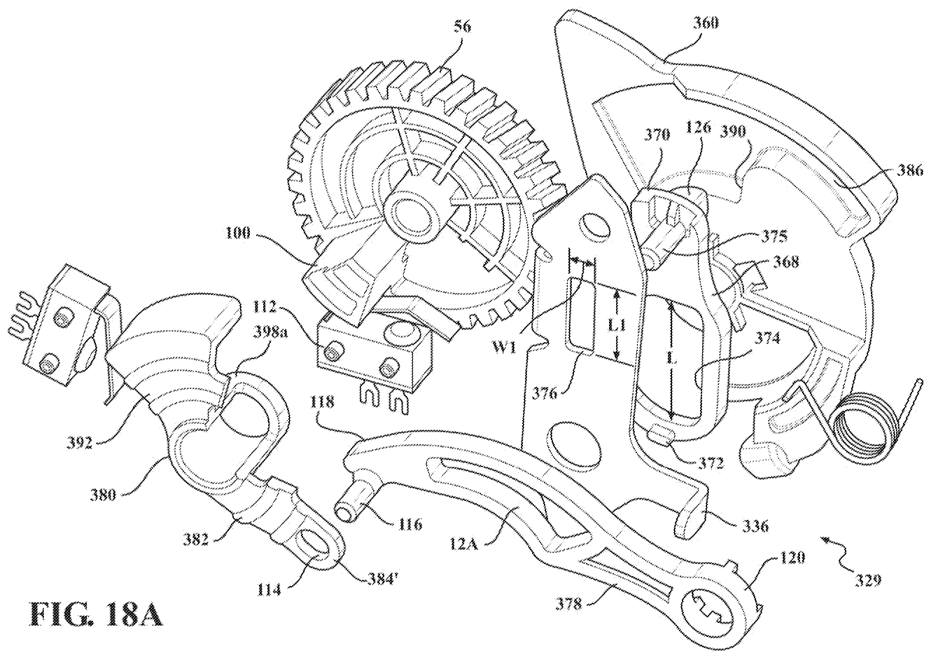

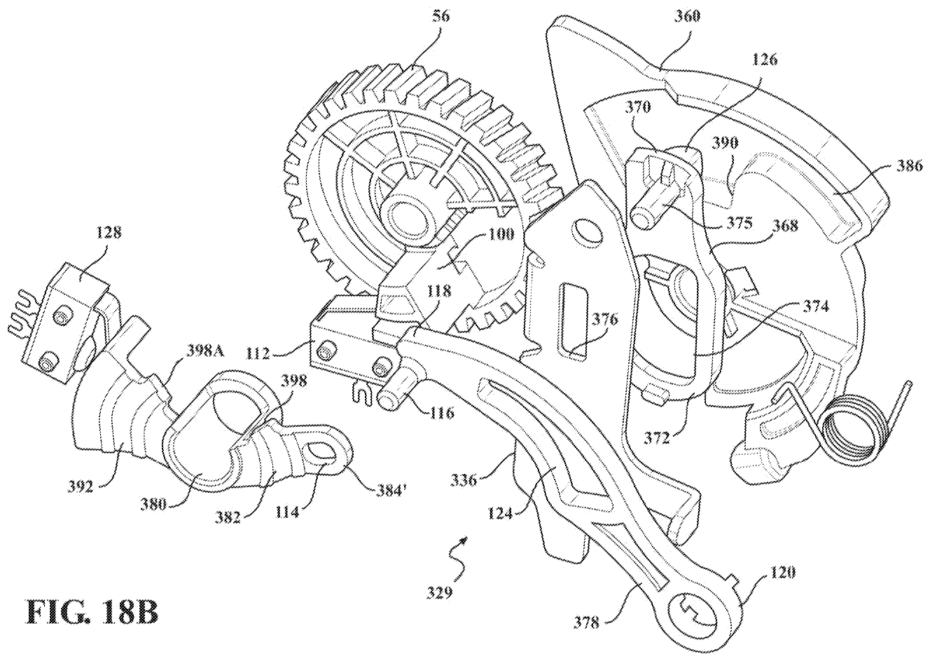

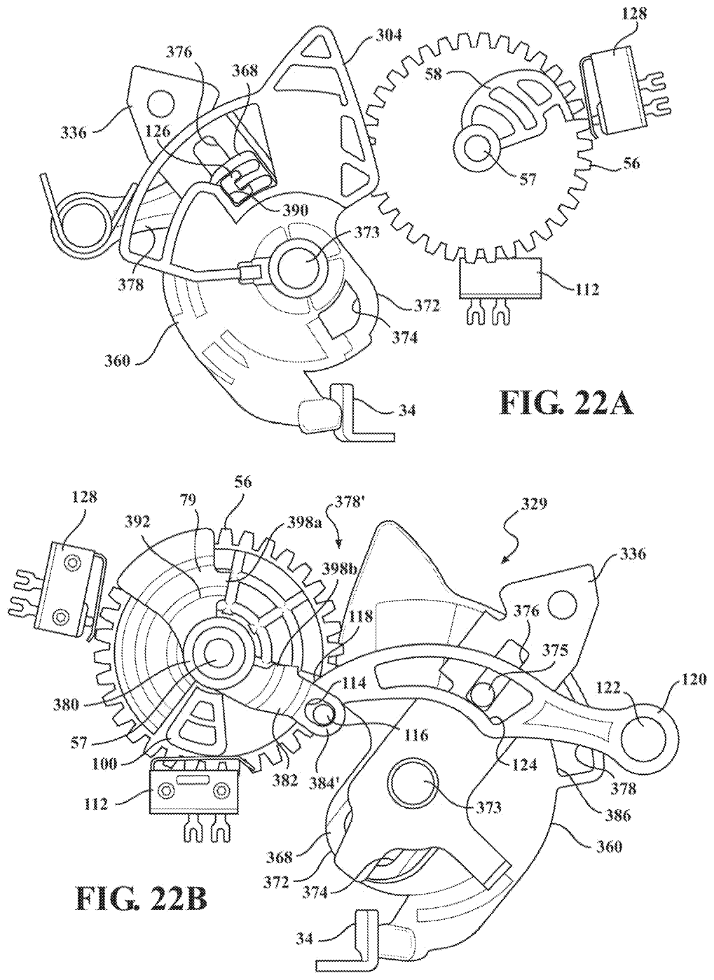

Referring to FIGS. 18A and 18B, link member 368 has a first end 370 operably coupled to release lever 336 for selective, automated movement of link member 368 between an engaged state and a disengaged state, and has a second end 372 pivotally supported by a first pin 373 also supporting release lever 336 and actuator lever 360 for rotation thereabout. Accordingly, first pin 373 serves as a common axis of rotation for release lever 336, actuator lever 360 and link member 368. First pin 373 is shown as extending within an elongate slot, also referred to as enlarged window or window 374, of link member 368, wherein window 374 has a length L (FIG. 18A) that allows link member 368 to translate relative to first pin 373 from a disengaged position (FIGS. 18B and 24A-26B) to an engaged position (FIGS. 18A-23B and 27A-27B). First end 370 of link member 368 is coupled to release lever 336 by a second pin 375 for relative translating movement with link member 368 through an elongate slot 376 of release lever 336. Slot 376 has a width W (FIG. 18A) preventing lateral play with second pin 375, such that width W1 establishes a line-to-line or slightly loose fit with an outer diameter of second pin 375. In contrast, a length L1 (FIG. 18A) of slot 376 allows second pin 375 to translate therein, thereby allowing link member 368 to translate relative to release lever 336 between its disengaged/decoupled and engage/coupled positions with actuator lever 360.

Movement of the link member 368 between its disengaged/decoupled and engaged/coupled states is facilitated by selective movement of an interlink assembly 378′. Interlink assembly 378′ includes a driven interlink lever, also referred to as unlock lever 378 and a drive interlink hub, also referred to as drive hub 79. Drive hub 79 has a central hub, referred to hereafter as hub 380, that is supported for selective rotation about release gear pin 57, about which power release gear 56 rotates. Drive hub 79 has a first drive arm 382 extending from hub 380 to a connection end 384′ configured for driving engagement with unlock lever 378 and a second arm 392 configured to facilitate moving unlock lever 378 to the desired engaged/coupled and disengaged/decoupled position. To facilitate coupling first arm 382 to connection end 384′ of unlock lever 378, an opening 114 can be provided adjacent connection end 384′, with opening 114 being configured for receipt of a pin 116, fixed to unlock lever 378, for pivotal movement therein. It is contemplated herein that the arrangement of opening 114 and pin 116 could be reversed, with opening being formed in unlock lever 378 and pin being fixed to first arm 382. Second arm 392 extends outwardly from hub 380 in generally diametrically opposed relation to first arm 382 to provide a first driven surface or member 398a against which drive member 100, fixed to power release gear 56, acts to facilitate moving unlock lever 378 to the engaged/coupled position, while first arm 382 extends outwardly from hub 380 in generally diametrically opposed relation to second arm 392 to provide a second driven surface or member 398b against which drive member 100 acts to facilitate moving unlock lever 378 to the disengaged/decoupled position.

Unlock lever 378 is configured to facilitate movement of link lever 368 to the desired engaged/coupled and disengaged/decoupled position in response to movement of power release gear 56 by being configured in operable communication with power release gear 56 via drive link 79. Unlock lever 378 extends between a first end 118 that is coupled to connection end 384′ via pin 116 extending through opening 114 and a second end 120. Second end 120 is configured for fixed pivotal movement about a pin 122, such that second end is fixed against translation. Unlock lever 378 has an elongate slot 124 extending intermediate first end 118 and second end 120, shown as being arcuate and extending in a lengthwise direction between first and second ends 118, 120. Slot 124 is configured for receipt of pin 375 therein, wherein a clearance fit is provided between pin 375 and slot 124 to allow pin 375 to slide in translating manner along the length of slot 124 during movement of link lever 368 between the desired engaged/coupled and disengaged/decoupled position. Unlock lever 378 is shown to be positioned adjacent to power release gear 56 in a different plane. In the illustrative example, unlock lever 378 and power release gear 56 are positioned about a common axis and are co-axial providing a compact space saving arrangement.

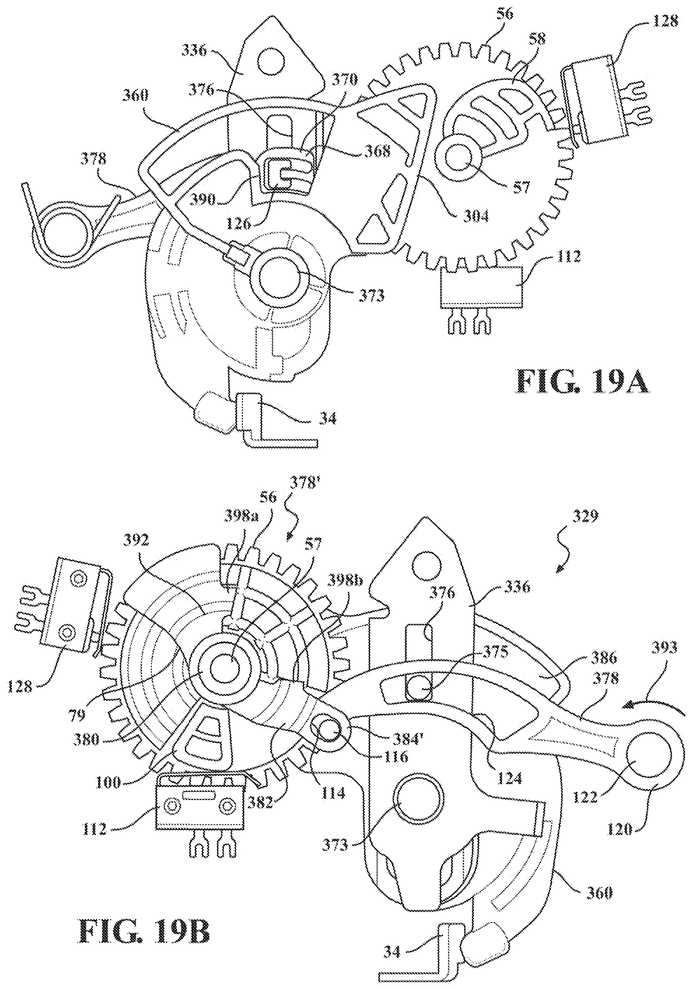

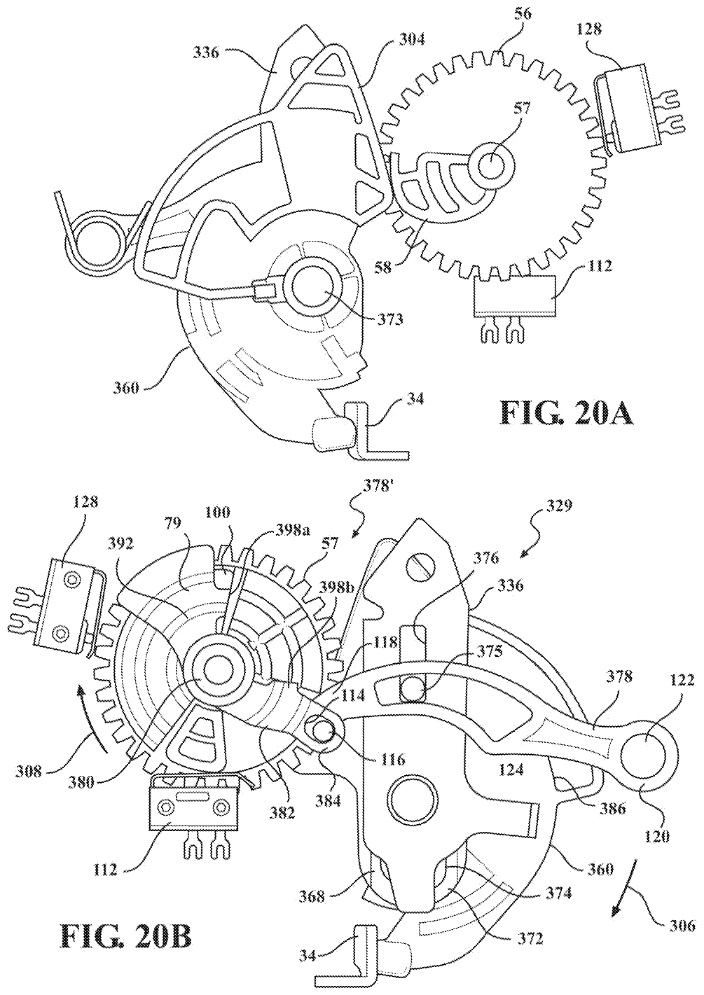

In normal powered operation, to open the vehicle door 12, the power release motor 50 is commanded via ECU 64 to drive power release worm gear 54 such that it drives power release gear 56 from a start position, also referred to as neutral or home position (FIGS. 19A and 19B), in a first, counterclockwise direction (as viewed in FIG. 19A) to an unlatched, also referred to as release, position. As power release gear 56 rotates, drive cam 58, fixed to power release gear 56, rotates in driving engagement with a driven cam surface 304 of actuator lever 360, thereby causing actuator lever 360 to rotate in the direction of arrow 306 (FIG. 20B) into driving engagement with pawl lever 34, which in turn drives pawl 32 rotatably to its ratchet releasing position, whereupon ratchet 30 rotates under a bias imparted by ratchet biasing member 46 to its striker release position. As shown in FIG. 20B, rotation of power release gear 56 causes drive member 100 to rotate in a direction of arrow 308 into confronting engagement with first driven member 398a of drive link 79, with override release mechanism 329 remaining in it engaged/coupled position. While in the release position illustrated in FIGS. 20A and 20B, swing door 12 is able to be opened.

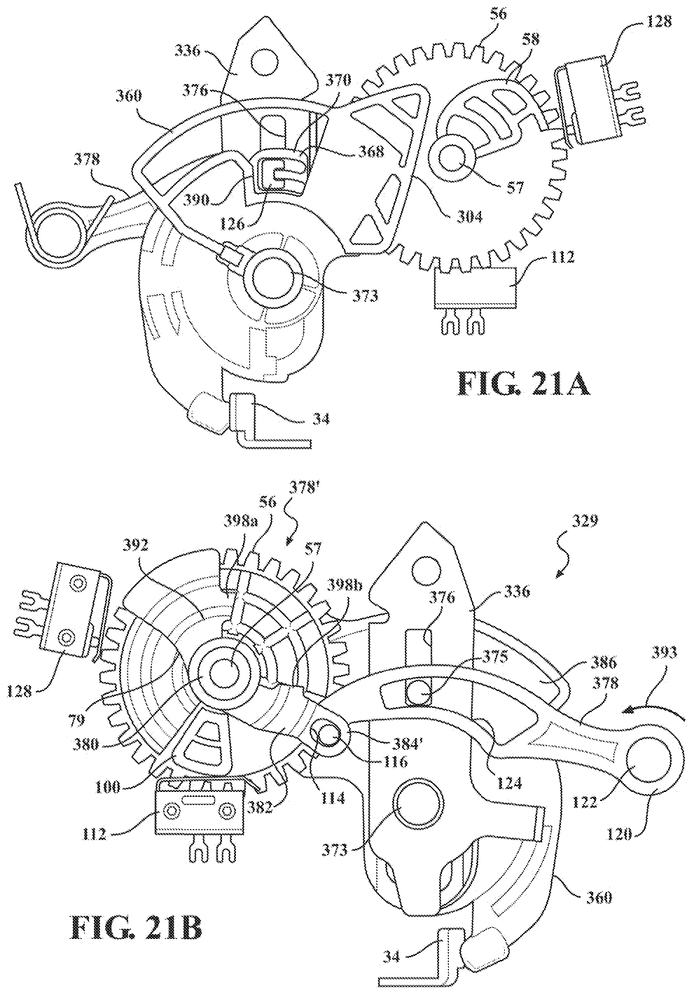

Upon the vehicle door 12 being opened, the power release motor 50 is commanded via ECU 64 of latch system 11 to drive power release worm gear 54 such that it drives power release gear 56 in a second, clockwise direction indicated by arrow 310, as viewed in FIG. 21A, until power release gear 56 reaches its home, rest position, which can be detected by a sensor 112 configured to detect a home position of drive member 100, by way of example and without limitation. As power release gear 56 rotates clockwise, override release mechanism 329 can remain in its engaged/coupled position via a unlock lever spring member 393 maintaining a counterclockwise bias on unlock lever 378, as viewed in FIGS. 17 and 19B.

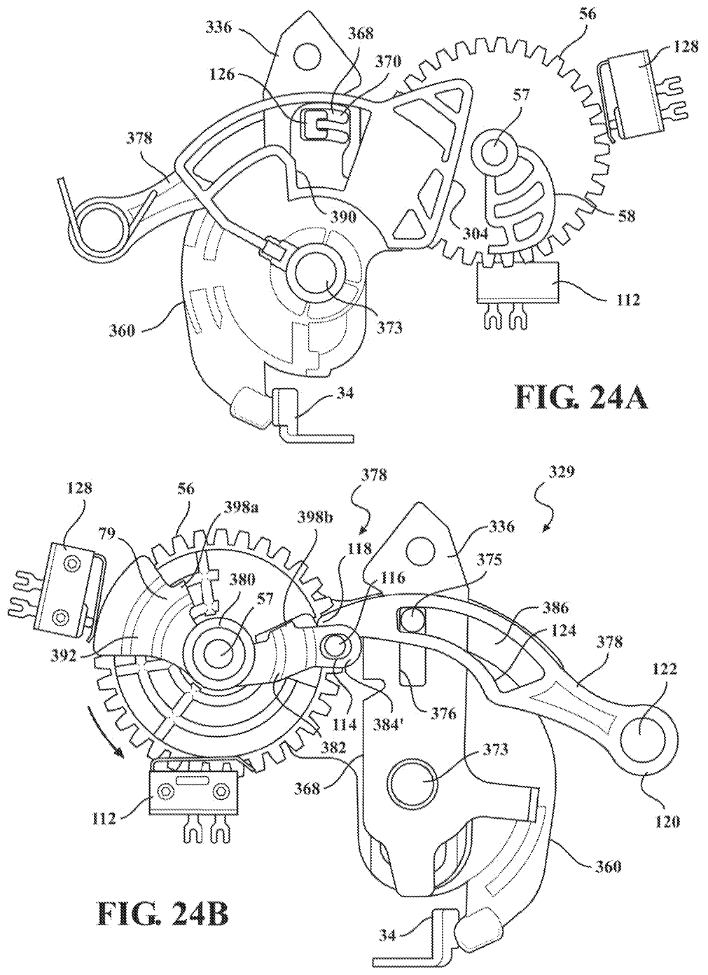

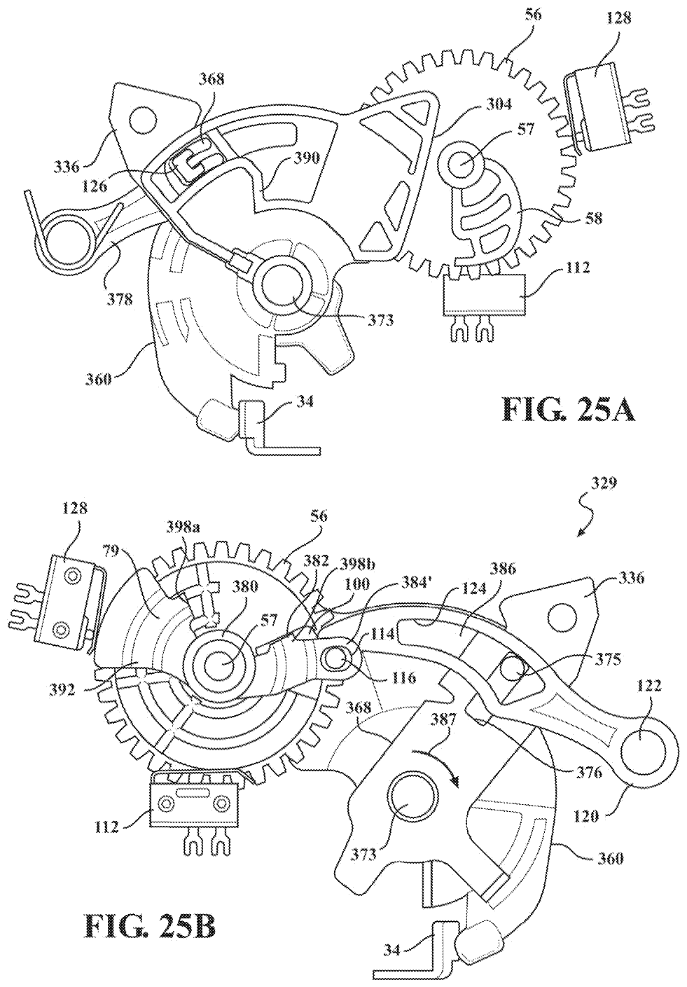

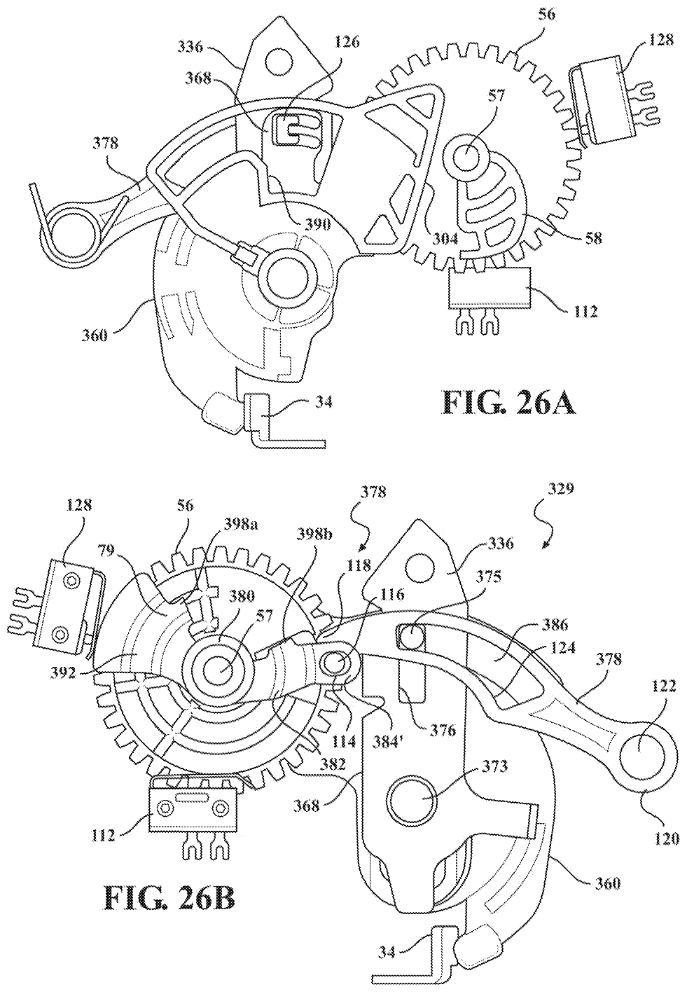

As shown in FIGS. 24A-25B, with override release mechanism 329 moved to its disengaged/decoupled position, such as in a child lock ON position, actuation of inside and/or outside door handle 24, 26 can cause release lever 336 and link member 368 to be rotated in the direction of arrow 387 (FIG. 25B), but latch mechanism 16 remains in its latched state, thereby preventing swing door 12 from being opened. As link member 368 is rotated, second pin 375 translates freely within slot 124 of unlock lever 378 in controlled fashion, being captive with slot 124, while unlock lever 378 remains stationary or nearly (substantially) stationary, and moves freely in unobstructed, clearance fashion through slot, also referred to as channel 386 of actuator lever 360. As such, no bias is imparted on actuator lever 360, and thus, actuator lever 360 remains stationary. Accordingly, pawl 32 remains in its ratchet holding position with ratchet 30, and thus, striker 18 remains captured by ratchet 30 while ratchet 30 remains in its striker capture position. In FIGS. 26A and 26B, release lever 336 is shown returned to its home or rest position upon release of the inside and/or outside door handle 24, 26.

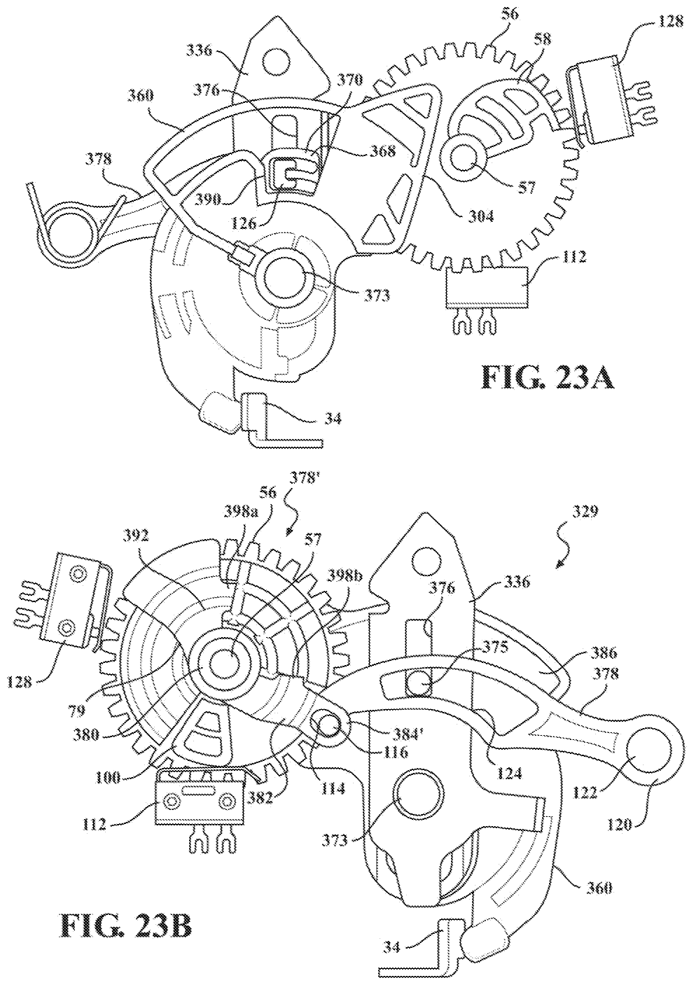

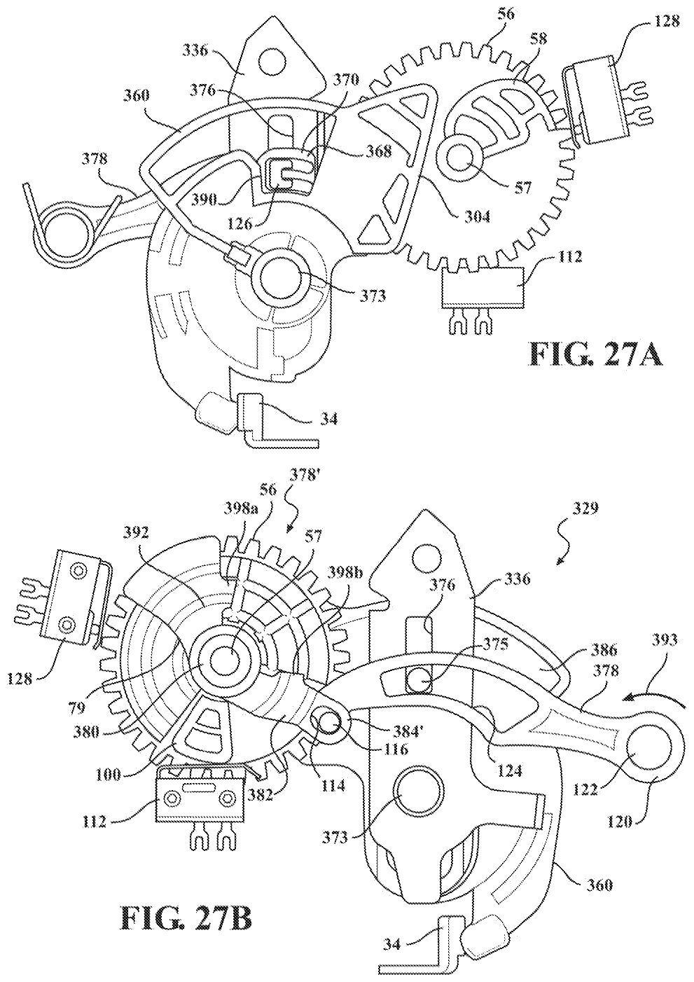

In a crash condition, when the override release mechanism 329 is initially in its disengaged/decoupled position, such as in a child lock ON position, as shown in FIGS. 24A and 24B, the following actuation is automated in response to crash detection sensors, such as proximity sensors 66 and the like, or when child lock is selectively (intentionally) disengaged, power release gear 56 is rotatably driven in a counterclockwise direction (as viewed in FIG. 24A) via command from ECU 64 to power release motor 50, whereupon drive member 100 on power release gear 56 moves away from second driven member 398b, thereby allowing the bias imparted by unlock lever spring member 393 to move unlock lever 378 in a counterclockwise direction, as viewed in FIG. 24B, such that unlock lever 378 pivots about pin 122 and drives pin 375 in translation along slot 376, thus, causing link member 368 to be moved from the disengaged/decoupled position to the engaged/coupled position. As such, a drive lug, also referred to as lug 126, extending from a second side of link member 368 opposite a first side from which the pin 375 extends, is moved from being aligned with channel 386, whereat child lock in ON, to being aligned with a drive shoulder 390 of actuator output lever 360, whereat child lock is OFF. During the counterclockwise movement of unlock lever 378, drive interlock hub 79 is caused to pivot in a clockwise direction via first drive arm 382 being driven by pin 116 fixed to unlock lever 378. As drive interlock hub 79 rotates clockwise, an end of second arm 392 moves out from engagement or proximity from a child lock sensor 128 (FIG. 27B) to signal ECU 64 accordingly, while drive member 100 moves into engagement or proximity with sensor 112, thereby causing ECU 64 to de-energize motor 50. As such, rotation of unlock lever 78 in the counterclockwise direction translates link member 368 into its engaged/coupled state, whereat drive lug 126 moves into position to confront and engage with drive shoulder 390 of actuation lever 360 (best seen in FIG. 27A). Accordingly, engagement of link member 368 only requires unlock lever 378 to be rotatably driven by unlock lever spring member 393 as drive lug 100 of power release gear 56 is moved away from biased engagement with first driven member 398a on second arm 392 of drive interlock hub 79, thereby providing a relatively simple, compact mechanism for actuating the mechanical release mechanism. As such, actuation of release lever 336 via manual actuation of inside and/or outside door handle 24, 26 drives drive lug 126 into driving engagement with drive shoulder 390, thereby causing actuation lever 360 to be driven conjointly with release lever 336. As such, actuation lever 360, as during a normal powered release operation discussed above, drives pawl release lever 34, thereby causing pawl 32 to be moved to its ratchet releasing position, and thus, causing ratchet 30 to move to its striker release position, whereat swing door 12 can be opened. Accordingly, swing door 12 is able to be opened via mechanical operation of inside and outside door handles 24, 26. Then, upon releasing inside and/or outside door handles 24, 26, Bowden cable 88 allows release lever 336 to return to its home, rest position, with link lever 368 returned to a rest position, though remaining in the engaged/coupled position with drive shoulder 90 (FIGS. 23A and 23B). Then, in the next power release operation performed as described above with regard to FIGS. 20A and 20B, rotation of power release gear 56 and drive member 100 fixed thereto causes mechanical override system 329 to be automatically reset, such that drive member 100 moves into biased engagement with second driven member 398b, as viewed in FIG. 24B, thereby causing unlock lever 378 to be driven clockwise against the bias of unlock lever spring member 393, whereupon link lever 368 is automatically returned to its disengaged/decoupled state, where it remains via bias imparted by drive member 100 on driven member 398b.

As such, latch assembly 10 is configured to be solely power actuated, if desired, while in a normal use state, wherein mechanical movement of inside and outside door handles 24, 26 is inoperable to effect unlatching actuation of the latch assembly 10. Further, latch assembly 10 is configured to be mechanically actuated while a child lock is disengaged and/or upon experiencing a crash condition, wherein mechanical movement of inside and/or outside door handle 24, 26 is operable to effect unlatching actuation of the latch assembly 10. In these embodiments, only one of the handles 24, 26 is shown connected to the release lever 36 via the Bowden cable 88, shown as the inside handle 24, by way of example and without limitation. It is to be recognized, in accordance with the teachings herein, that inside door handle 24 and outside door handle 26 may be both operatively connected to the release lever 36, such as via a splitter mechanism (not shown), such that a movement of either inside and outside handles 24, 26 may be operative to effect unlatching actuation of the latch assembly 10.

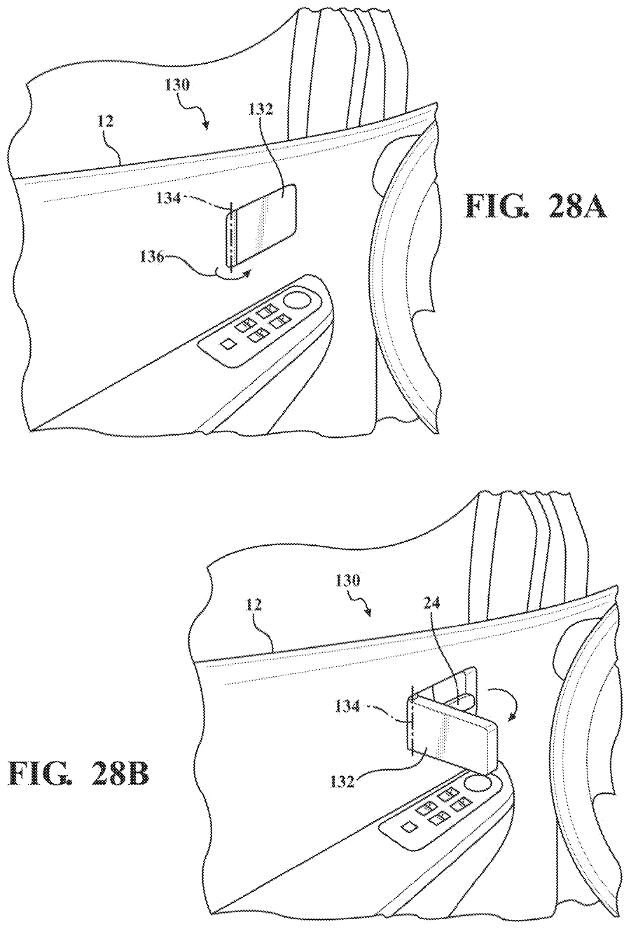

In FIGS. 28A and 28B, a double actuation mechanism 130 in accordance with another aspect of the disclosure, wherein the double actuation mechanism 130 requires at least two deliberate actions to mechanically release the door 12 of the motor vehicle 14 via an inside door handle 24. The double actuation mechanism 130 is shown having a cover, also referred to as flap 132, wherein the flap 132 is configure for movement between a first position (FIG. 28A), whereat flap 132 conceals inside door handle 24 against being actuated, and a second position (FIG. 28B) whereat flap 132 is moved, such as in pivotal fashion about a hinge 134, to allow access to inside door handle 24 such that inside door handle 24 can be grasped and actuated (pulled or otherwise moved). Flap 132 can be biased to a closed position (FIG. 28A) via any suitable type of spring member, such as a torsion spring 136, by way of example and without limitation. When desired to gain access to the inside door handle 24 to initiate mechanical release of the door 12, with the door 12 in the closed state, a method 1000 of performing multiple actions to actuate double actuation mechanism 130 can be performed. The method 1000 includes a step 1100 of opening the flap 132 when the door is closed 1002 via a first deliberate (intentional) action, such as by pulling the flap 132 outwardly against the bias imparted by spring member 136 to expose the inside door handle 24. Then, a step 1200 of opening the door 12 can be performed via a second deliberate (intentional) action, such as by pulling the inside door handle 24. The PCL status 1202 can be set to Lock 1204 or unlock 1206. From Unlock 1206, the door may be opened 1208. If the link member 68, 368 of the mechanical override release mechanism 29, 329 is in the engaged/coupled position, latch mechanism 16, 316 is released and door 12 is able to be moved to the open position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly (10, 310) for a vehicle door (12), comprising:
a ratchet (30) configured for movement between a striker capture position and a striker release position and being biased toward said striker release position;
a pawl (32) configured for movement between a ratchet holding position whereat said pawl (32) maintains said ratchet (30) in said striker capture position and a ratchet releasing position whereat said pawl (32) releases said ratchet (30) for movement of said ratchet (30) to said striker release position;
a pawl release lever (34) configured to selectively move said pawl (32) from said ratchet holding position to said ratchet releasing position;
an override release mechanism (29, 329) configured for mechanical actuation by at least one of an inside door handle (24) and an outside door handle (26) and being moveable between a disengaged position, whereat said override release mechanism (29, 329) is disengaged from operable communication with said pawl release lever (34), and an engaged position, whereat said override release mechanism (29, 329) is engaged in operable communication with said pawl release lever (34); and
a power release actuator system (38) configured to control powered actuation of said pawl release lever (34) to move said pawl (32) from said ratchet holding position to said ratchet releasing position and to maintain said override release mechanism (29, 329) in said disengaged position during normal operation of the power latch assembly (10, 310) and to selectively move said override release mechanism (29, 329) to said engaged position.

2. The power latch assembly (10, 310) of claim 1, wherein said power release actuator system (38) includes a motor (50) and a drive gear (54) driven by said motor (50), said drive gear (54) being in meshed engagement with a power release gear (56) having a release cam (58) fixed thereto, and further including an actuator output lever (60, 360) configured for movement in response to engagement with said release cam (58) as said power release gear (56) is rotated via driven movement of said drive gear (54) by said motor (50), wherein said actuator output lever (60, 360) is configured to move said pawl release lever (34) and cause said pawl (32) to move between said ratchet holding and releasing positions.

3. The power latch assembly (10, 310) of claim 2, wherein said override release mechanism (29, 329) includes a release lever (36, 336) operably connected with the at least one of the inside door handle (24) and the outside door handle (26) and a link member (68, 368) configured for movement in response to movement of said release lever (36, 336), said link member (68, 368) being moveable to a decoupled position relative to said actuator output lever (60, 360) to maintain said override release mechanism (29, 329) in said disengaged position and to a coupled position relative to said actuator output lever (60, 360) to move said override release mechanism (29, 329) to said engaged position.

4. The power latch assembly (10, 310) of claim 3, wherein said link member 68, 368) is operably connected to said release lever (36, 336) by a pin (75, 375) fixed to said link member (68, 368), wherein said pin (75, 375) is configured for relative movement with said actuator output lever (60, 360) between said decoupled position and said coupled position.

5. The power latch assembly (10) of claim 4, wherein said actuator output lever (60) has a channel (86) and a drive shoulder (90), said pin (75) being configured for relative movement with said actuator output lever (60) while in said channel (86) and being configured for conjoint movement with said actuator output lever (60) while in engagement with said shoulder (90).

6. The power latch assembly (10, 310) of claim 3, further including an unlock lever (78, 378) configured for operable communication with said link member (68, 368) and further including a lug (100) configured for conjoint rotation with said power release gear (56), said lug (100) being configured for operable communication with said unlock lever (78, 378) upon rotating said power release gear (56) in a first direction to bring said unlock lever (78, 378) into driving communication with said link member (68, 368) to move said link member (68, 368) from said decoupled position to said coupled position.

7. The power latch assembly (10, 310) of claim 6, wherein said lug (100) is configured for operable communication with said unlock lever (78, 378) upon rotating said power release gear (56) in a second direction opposite said first direction to bring said unlock lever (78, 378) into driving engagement with said link member (68, 368) to facilitate moving said link member (68, 368) from said coupled position to said decoupled position.

8. The power latch assembly (10) of claim 6, wherein said unlock lever (78) is configured for rotation about a common axis with said power release gear (56).

9. The power latch assembly (10) of claim 6, further including a biasing member (93) configured to impart a bias on said unlock lever (78) to releasably maintain said link member (68) in each of the coupled position and the decoupled position.

10. The power latch assembly (10) of claim 9, wherein said lug (100) imparts a bias on said unlock lever (78) during rotation of said power release gear (56) in the first and second directions to overcome the bias imparted by said biasing member (93) on said unlock lever (78) to toggle said unlock lever (78) between locked and unlocked positions.

11. The power latch assembly (10, 310) of claim 6, further including a control unit (64) in electrical communication with said motor (50), said control unit (64) being configured in electrical communication with at least one sensor configured to detect a crash condition, said control unit (64) automatically energizing said motor (50) in response to a detected crash to move said power release gear (56) in said first direction to cause said lug (100) to move said link member (68, 368) to the coupled position with said actuator output lever (60, 360) to move said override release mechanism (29, 329) to said coupled position relative to said actuator output lever (60, 360).

12. The power latch assembly (10, 310) of claim 11, wherein said control unit (64) is configured to automatically energize said motor (50) in response to a child lock being disengaged to move said power release gear (56) in said first direction to cause said lug (100) to move said link member (68, 368) to the coupled position with said actuator output lever (60, 360) to move said override release mechanism (29, 329) to said engaged position.

13. The power latch assembly (10, 310) of claim 4, wherein said release lever (36, 336) has a slot (76, 376) and said pin (75, 375) extends through said slot (76, 376), said pin (75, 375) being configured for sliding translation in said slot (76, 376) when said link member (68, 368) moves between said decoupled position and said coupled position.

14. The power latch assembly (310) of claim 7, wherein said unlock lever (378) has a slot (124) configured for receipt of a pin (375) extending from a first side of said link member (368) therein, said pin (375) being configured to translate in said slot (124) in response to movement of said release lever (336).

15. The power latch assembly (310) of claim 14, wherein said actuator output lever (360) has a channel (386) and a drive shoulder (390) and wherein said link member (368) has a drive lug (126) extending from a second side of said link member (368) opposite said first side, said drive lug (126) being configured for relative movement with said actuator output lever (360) while in said channel (386) and being configured for conjoint movement with said actuator output lever (360) while in engagement with said drive shoulder (390).

16. The power latch assembly (10, 310) of claim 15, wherein said release lever (336) has a slot (376) and said pin (375) extends through said slot (376), wherein said unlock lever (378) drives said pin (375) in sliding translation in said slot (376) in response to movement of said power release gear (56) in the first direction to bring said drive lug (126) into confronting relation with said drive shoulder (390), and wherein said unlock lever (378) drives said pin (375) in sliding translation in said slot (376) in response to movement of said power release gear (56) in the second direction to bring said drive lug (126) into alignment with said channel (386).

17. A method of operating the power latch assembly, comprising:
operating a prime mover configured to control powered actuation of a power release actuator system including a pawl and a ratchet during a normal mode of the power latch assembly to move the pawl from a ratchet holding position to a ratchet releasing position and to maintain an override release mechanism in a disengaged state whereat the override release mechanism operably decouples at least one of an inside door handle and an outside door handle from the pawl.

18. The method of claim 17, further including operating the prime mover during a manual mode of the power latch assembly to transition the override release mechanism to an engaged state whereat the override release mechanism operably couples at least one of the inside door handle and the outside door handle with the pawl.

19. The method of claim 18, further including configuring the override release mechanism to operably couple the inside door handle with the pawl in the engaged state.

20. The method of claim 19, further including configuring the override release mechanism to operably couple the inside door handle and the outside door handle with the pawl in the engaged state.
